(19) United States
(12) Patent Application Publication
(10) Pub. No.: US 2026/0371459 A1
(43) Pub. Date: Nov. 19, 2026

(54) VEHICLE LAMP CONTROL DEVICE

(71) Applicant: KOITO MANUFACTURING CO., LTD., Tokyo (JP)

(72) Inventors: Norito TAKAHASHI, Shizuoka-shi, Shizuoka (JP); Hiroyasu KAWAI, Shizuoka-shi, Shizuoka (JP)

(73) Assignee: KOITO MANUFACTURING CO., LTD., Tokyo (JP)

(21) Appl. No.: 19/136,224

(22) PCT Filed: Nov. 20, 2023
(86) PCT No.: PCT/JP2023/041576

§ 371 Date: Jun. 5, 2025

(30) Foreign Application Priority Data
Dec. 14, 2022 (JP) 2022-199511
Dec. 14, 2022 (JP) 2022-199512
Dec. 14, 2022 (JP) 2022-199513

(51) Int. Cl. H05B 45/345; B60Q 1/04; B60Q 1/26; H05B 45/395; H05B 45/54; H05B 47/23; H05B 47/25; H05B 47/28

(52) U.S. Cl. CPC H05B 45/345; B60Q 1/04; B60Q 1/26; H05B 45/395; H05B 45/54; H05B 47/235; H05B 47/25; H05B 47/28

(57) ABSTRACT

To solve an issue raised in controlling the lighting of a light-emitting element constituting a vehicle lamp. A vehicle lamp control device, for example, includes: a first constant current source configured to supply a constant current to a light-emitting element used in a vehicle lamp; a resistance circuit connected in series to the light-emitting element and the first constant current source; a current value control circuit configured to control a value of a current of the first constant current source in response to a lighting state instruction for giving an instruction of a lighting state of the light-emitting element; and a resistance value control circuit configured to change a resistance value of the resistance circuit so as to suppress a change in a value of a voltage applied to the first constant current source when a value of a current supplied to the light-emitting element changes.

### CROSS-REFERENCE TO RELATED APPLICATIONS

This application is a 371 U.S. National Phase of International Application No. PCT/JP2023/041576, filed on Nov. 20, 2023, which claims priority to Japanese Patent Application Nos. 2022-199511, 2022-199512, and 2022-199513, all of which were filed Dec. 14, 2022. The entire disclosures of the above applications are incorporated herein by reference.

### TECHNICAL FIELD

The present disclosure relates to a vehicle lamp control device.

### BACKGROUND ART

In recent years, there has been increasing market needs to perform various expressions such as display of animation and the like by using lamps that are mounted to vehicles (hereinafter referred to as “vehicle lamps”) such as headlamps and rear lamps, and to perform high-density information transmission (communication) with external objects and people (following vehicles, oncoming vehicles, drivers of other vehicles, pedestrians, etc.). Meanwhile, in association with the diversification and complication of expressions required for vehicle lamps, efforts are being made to unify and standardize the mechanism to control lighting and to improve the efficiency of software management systems using mechanisms such as Over The Air (OTA) and the like.

For example, Patent Literature 1 describes a vehicle lamp configured to integrally control a plurality of lamps. Further, for example, Patent Literature 2describes a vehicle control device (electronic control unit) configured to update software stored in an Electronic Control Unit (ECU) mounted to a vehicle, by OTA.

### CITATION LIST

### Patent Literature

[PTL 1] Japanese Patent Application Publication No. 2022-49515

[PTL 2] Japanese Patent Application Publication No. 2019-144669

[PTL 3] International Publication No. WO 2019/098138

### SUMMARY OF INVENTION

### Technical Problem

When implementing various expressions, such as display of animation and the like, using, as a light source, a light-emitting element whose lighting is controlled based on constant current control, such as a Light-Emitting Diode (LED), it is needed to change the value of the current (constant current) supplied from the constant current source to the light-emitting element, depending on the contents of the expression. In addition, when the software for controlling the lighting of the light-emitting element is updated at any time by OTA or the like, the value of the current supplied from the constant current source to the light-emitting element may change before and after the software is updated.

When the value of the current (constant current) supplied from the constant current source to the light-emitting element is changed in this way, the value of the voltage (hereinafter referred to as “Vk”) applied to the constant current source may change. For this reason, there is a possibility that power consumption and heat generation may increase due to an excessive voltage value (Vk) applied to the constant current source, or that the light-emitting element may fail to light up due to the value of the voltage (Vk) applied to the constant current source decreasing below the value needed to properly operate the constant current source (becoming excessively low) (see, for example, Patent Literature 3). Therefore, some measures should be taken against such an issue, when implementing various expressions using vehicle lamps and improving the efficiency of the lighting control mechanism.

Further, a change in the current flowing through the light-emitting element can be a factor in changes in the temperature of the light-emitting element. In addition, the temperature of the light-emitting element also changes depending on the environment in which the vehicle is placed, due to self-heating of the light-emitting element, and the like.

Here, when the temperature of the light-emitting element changes, and the value of the voltage (hereinafter referred to as “Vk”) applied to the constant current source changes due to the temperature characteristics of the light-emitting element, there is a possibility of an increase in power consumption and heat generation caused by the value of the voltage (Vk) applied to the constant current source becoming excessively large, or a possibility that the light-emitting element fails to light up due to the value of the voltage (Vk) applied to the constant current source decreasing below the value needed to properly operating the constant current source (becoming excessively low) (see, for example, Patent Document 3). Accordingly, some measures should be taken against such an issue in controlling the lighting of the light-emitting elements constituting the vehicle lamp.

Further, in a vehicle lamp that is used as a light-emitting element, such as a Light-Emitting Diode (LED), whose lighting is controlled based on constant current control, a short circuit of the light-emitting element may increase the value of the current flowing through the light-emitting element, which may result in an increase in the voltage applied to the constant current source, which may leads to an increase in power consumption and heat generation (see, for example, Patent Literature 3).

The vehicle lamp described in Patent Literature 1 mentioned above is to control the state of lighting of a plurality of light sources according to the state of a plurality of lighting requests by integrated software processing using a signal processing device, but does not mention the issue described above. Further, the technology described in Patent Literature 2 is configured for the purpose of eliminating restrictions on the timing at which program update processing is executed, and does not describe the issue described above.

The present disclosure has been provided in view of such a background, and is directed to provision of a vehicle lamp control device capable of solving an issue raised in controlling the lighting of a light-emitting element constituting a vehicle lamp.

### Solution to Problem

An aspect of the present disclosure is a vehicle lamp control device comprising: a first constant current source configured to supply a constant current to a light-emitting element used in a vehicle lamp; a resistance circuit connected in series to the light-emitting element and the first constant current source; a current value control circuit configured to control a value of a current of the first constant current source in response to a lighting state instruction for giving an instruction of a lighting state of the light-emitting element; and a resistance value control circuit configured to change a resistance value of the resistance circuit so as to suppress a change in a value of a voltage applied to the first constant current source when a value of a current supplied to the light-emitting element changes.

This makes it possible to solve an issue raised in controlling the lighting of a light-emitting element constituting the vehicle lamp.

Further, another aspect of the present disclosure is a vehicle lamp control device comprising: a first constant current source configured to supply a constant current to a light-emitting element used in a vehicle lamp; a resistance circuit connected in series to the light-emitting element and the first constant current source; a current value control circuit configured to control a value of a current of the first constant current source; and a resistance value control circuit configured to change a resistance value of the resistance circuit so as to suppress a change in a value of a voltage applied to the first constant current source when a temperature around the light-emitting element changes.

This makes it possible to solve an issue raised in controlling the lighting of a light-emitting element constituting the vehicle lamp.

Further, another aspect of the present disclosure is a vehicle lamp control device comprising: a first constant current source configured to supply a constant current to a light-emitting element used in a vehicle lamp; a resistance circuit connected in series to the light-emitting element and the first constant current source; a current value control circuit configured to control a value of a current of the first constant current source; and a resistance value control circuit configured to change a resistance value of the resistance circuit so as to suppress a change in a value of a voltage applied to the first constant current source when the light-emitting element is short-circuited.

This makes it possible to solve an issue raised when a light-emitting element constituting the vehicle lamp is short-circuited.

An issue other than the above disclosed in the present application and a solution thereof will become apparent from the description of embodiments and drawings.

### advantageous Effects of Invention

According to the present disclosure, it is possible to solve an issue raised in controlling lighting of a light-emitting element constituting a vehicle lamp.

### BRIEF DESCRIPTION OF DRAWINGS

FIG. 1 is a diagram illustrating a schematic configuration of an electronic control system mounted to a vehicle.

FIG. 2 is a diagram illustrating a configuration of a vehicle lamp control device.

FIG. 3 is a diagram illustrating configurations of a rear lamp lighting control circuit and an LED board.

FIG. 4A is a diagram for explaining an issue in controlling the lighting of an LED driven by a constant current.

FIG. 4B is a diagram for explaining an issue in lighting controlling the lighting of an LED driven by a constant current.

FIG. 5A is a diagram illustrating an example of a vehicle lamp control device according to an embodiment of the present disclosure.

FIG. 5B is a diagram illustrating an example of a vehicle lamp control device according to an embodiment of the present disclosure.

FIG. 5C is a diagram illustrating an example of a vehicle lamp control device according to an embodiment of the present disclosure.

FIG. 5D is a diagram illustrating an example of a vehicle lamp control device according to an embodiment of the present disclosure.

FIG. 5E is a diagram illustrating an example of a vehicle lamp control device according to an embodiment of the present disclosure.

FIG. 6A is a diagram illustrating an example of a vehicle lamp control device according to an embodiment of the present disclosure.

FIG. 6B is a diagram illustrating an example of a vehicle lamp control device according to an embodiment of the present disclosure.

FIG. 6C is a diagram illustrating an example of a vehicle lamp control device according to an embodiment of the present disclosure.

FIG. 6D is a diagram illustrating an example of a vehicle lamp control device according to an embodiment of the present disclosure.

FIG. 7 is a diagram illustrating an example of a current source.

FIG. 8A is a diagram for explaining an issue in controlling the lighting of an LED driven by a constant current.

FIG. 8B is a diagram for explaining an issue in controlling the lighting of an LED driven by a constant current.

FIG. 9A is a diagram illustrating an example of a vehicle lamp control device according to an embodiment of the present disclosure.

FIG. 9B is a diagram illustrating an example of a vehicle lamp control device according to an embodiment of the present disclosure.

FIG. 9C is a diagram illustrating an example of a vehicle lamp control device according to an embodiment of the present disclosure.

FIG. 9D is a diagram illustrating an example of a vehicle lamp control device according to an embodiment of the present disclosure.

FIG. 9E is a diagram illustrating an example of a vehicle lamp control device according to an embodiment of the present disclosure.

FIG. 10A is a diagram illustrating an example of a vehicle lamp control device according to an embodiment of the present disclosure.

FIG. 10B is a diagram illustrating an example of a vehicle lamp control device according to an embodiment of the present disclosure.

FIG. 10C is a diagram illustrating an example of a vehicle lamp control device according to an embodiment of the present disclosure.

FIG. 10D is a diagram illustrating an example of a vehicle lamp control device according to an embodiment of the present disclosure.

FIG. 11 is a diagram illustrating an example of a current source.

FIG. 12 is a diagram for explaining an issue in controlling the lighting of an LED driven by a constant current.

FIG. 13A is a diagram illustrating an example of a vehicle lamp control device according to an embodiment of the present disclosure.

FIG. 13B is a diagram illustrating an example of a vehicle lamp control device according to an embodiment of the present disclosure.

FIG. 13C is a diagram illustrating an example of a vehicle lamp control device according to an embodiment of the present disclosure.

FIG. 13D is a diagram illustrating an example of a vehicle lamp control device according to an embodiment of the present disclosure.

FIG. 13E is a diagram illustrating an example of a vehicle lamp control device according to an embodiment of the present disclosure.

FIG. 14A is a diagram illustrating an example of a vehicle lamp control device according to an embodiment of the present disclosure.

FIG. 14B is a diagram illustrating an example of a vehicle lamp control device according to an embodiment of the present disclosure.

FIG. 14C is a diagram illustrating an example of a vehicle lamp control device according to an embodiment of the present disclosure.

FIG. 14D is a diagram illustrating an example of a vehicle lamp control device according to an embodiment of the present disclosure.

FIG. 15 is a diagram illustrating an example of a current source.

### DESCRIPTION OF EMBODIMENTS

Hereinafter, embodiments will be described with reference to the drawings. In the following description, the same or similar configurations may be given the same reference numerals, and redundant descriptions thereof may be omitted. Further, in the following description, when configurations of the same type needs to be distinguished, a subscript (number, alphabet, etc.) may be added after the reference numeral that collectively refers to the configuration.

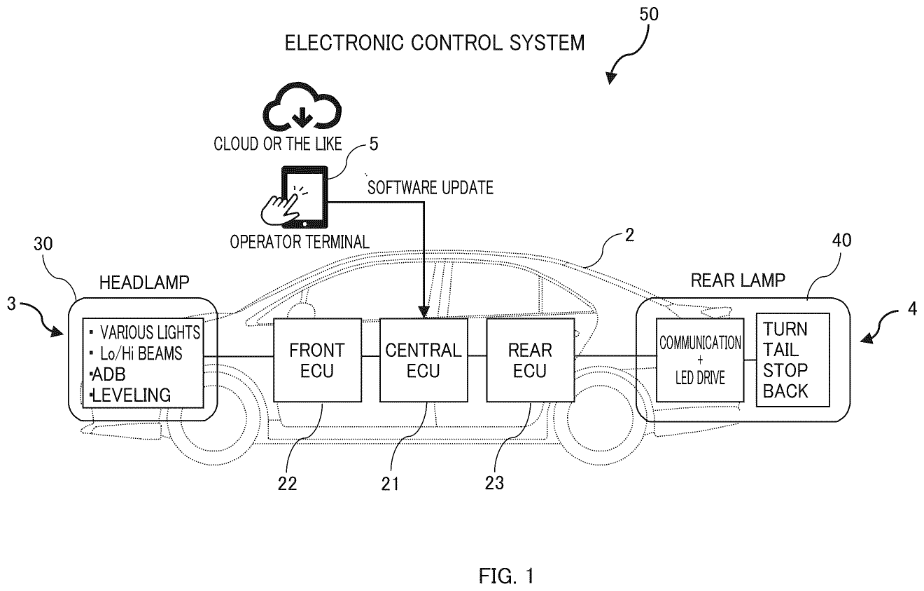

FIG. 1 illustrates a schematic configuration of an electronic control system 50 mounted to a vehicle 2, illustrated as an embodiment of the present disclosure. The illustrated electronic control system 50 includes various Electronic Control Units (ECUs) that control parts of the vehicle 2 (powertrain ECU, chassis ECU, body ECU, multimedia ECU, Advanced Driver-Assistance Systems (ADAS) ECU, etc.). Each of the ECUs includes a processor (Central Processing Unit (CPU), Micro Processing Unit (MPU), etc.), a storage device (memory, SSD, hard disk, portable recording medium, etc.), and a communication device (CAN transceiver, etc.), and functions as an information processing device (computer). The figure illustrates a configuration in which the body ECU is centered among the various ECUs mounted to the vehicle 2.

As illustrated in the figure, the electronic control system 50 includes a central ECU 21 (first information processing device), a front ECU 22 (second information processing device), and a rear ECU 23 (second information processing device). The electronic control system 50 controls, for example, lamps of the vehicle 2 (hereinafter referred to as “vehicle lamps”) such as a headlamp 30, a rear lamp 40 and the like.

The central ECU 21 is communicably connected to the front ECU 22 and the rear ECU 23, and performs overall control of the front ECU 22 and the rear ECU 23. The central ECU 21 operates as, for example, a master device, and the front ECU 22 and the rear ECU 23 operate as, for example, slave devices.

The front ECU 22 is communicably connected to the headlamp 30. The rear ECU 23 is communicably connected to the rear lamp 40. The headlamp 30 includes elements 3 such as, for example, a headlamp, a small lamp, a fog lamp, a Daytime Running Lamp (DRL), a Clearance Lamp (CLL), a Lo/Hi beam control mechanism, an Adaptive Driving Beam (ADB), and an auto-leveling system. The rear lamp 40 includes elements 4 such as, for example, a turn signal lamp, a tail lamp, a stop lamp, and a back lamp.

The central ECU 21 transmits instruction information (hereinafter referred to as “lighting method instruction”) of a method of lighting (mode of lighting) to the front ECU 22 and the rear ECU 23. In addition, the central ECU 21 acquires operation information from each of the front ECU 22 and the rear ECU 23, and provides the acquired operation information to the outside of the vehicle 2 and performs other operations.

Further, the central ECU 21 communicates (wireless communication or wired communication (for example, Over The Air (OTA) communication)) with an external device (for example, an operator terminal 5) of the vehicle 2. By communicating with an external device, the central ECU 21 acquires update information (including update differences) of software (including firmware) stored (memorized) in the front ECU 22 and the rear ECU 23. The above software includes, for example, software (e.g., execution code of a program for generating a lighting state instruction, which will be described later) for implementing various expressions, such as display of animation and the like, using the vehicle lamp.

Communication methods used for communication between the central ECU 21, the rear ECU 23, and the rear lamp 40 include Controller Area Network (CAN), CAN Flexible Data rate (CAN FD), Local Interconnect Network (LIN), FlexRay (registered trademark), Ethernet (registered trademark), and various serial communication methods, but the communication method is not necessarily limited thereto.

Here, as a mechanism to control the lighting of the light-emitting elements that constitute the light source of the vehicle lamp, the mainstream is one in which an overall ECU such as the central ECU 21 or the like transmits control instructions individually to control devices (microcomputers, etc.) provided in respective vehicle lamps, and each of the control devices controls a driver circuit (driver IC, etc.) to control the lighting of the light-emitting element.

On the other hand, in the electronic control system 50 illustrated in FIG. 1, an ECU, positioned under the control of the central ECU 21, such as the front ECU 22 and the rear ECU 23, which is interposed between the central ECU 21 and the vehicle lamp, transmits a control instruction to the driver circuit of the vehicle lamp to control the lighting of the light-emitting element. Therefore, the load on the central ECU 21 is reduced, and by virtue of the front ECU 22 and the rear ECU 23, it is possible to perform lighting with a high load, such as display of animation and the like.

Further, in the electronic control system 50 illustrated in FIG. 1, since the lighting control of the light-emitting elements by the front ECU 22 and the rear ECU 23 is mainly performed by software, it is not necessary to provide the vehicle lamp with hardware specialized for a specific function (turn signal display, tail display, stop display, back display, etc.), thereby being able to simplify the configuration, improve productivity, reduce the maintenance burden, and so on.

Further, in the electronic control system 50 illustrated in FIG. 1, the software for implementing the functions of the front ECU 22 and the rear ECU 23 can be updated at any time, and the method of lighting (mode of lighting) the vehicle lamp can be easily and quickly changed without changing the hardware. Therefore, it is possible to flexibly and quickly respond to various needs for the method of lighting the vehicle lamp, such as display of animation and the like.

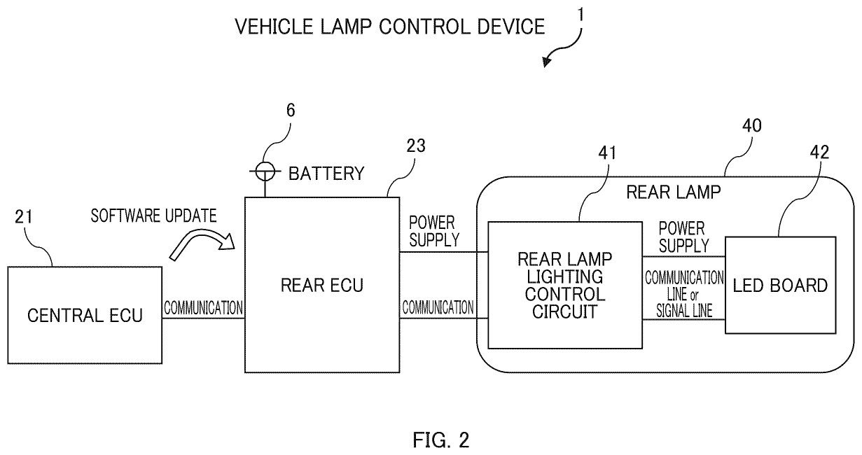

FIG. 2 is a block diagram illustrating a configuration (hereinafter referred to as “vehicle lamp control device 1”) focusing on the peripheral of the rear ECU 23 in the configuration of the electronic control system 50 illustrated in FIG. 1. In the figure, a configuration is illustrated assuming that the rear ECU 23 controls the lighting of the rear lamp 40, which is the element 4 provided on the rear side of the vehicle 2.

As illustrated in the figure, the rear lamp 40 includes a rear lamp lighting control circuit 41 and an LED board 42. The rear lamp lighting control circuit 41 is communicably connected to the rear ECU 23. The rear lamp lighting control circuit 41 and the LED board 42 are connected with a communication line (CAN, LIN, etc.) or a signal line (direct line (direct wiring)). Meanwhile, one or more light-emitting elements constituting the light source of the vehicle lamp are mounted to the LED board 42. In an embodiment of the present disclosure, the case where the light-emitting element is an Light-Emitting Diode (LED) will be described as an example, but the light-emitting element may be another type of light-emitting element (for example, a laser diode, an organic EL (Organic Electro-Luminescence (OEL)), etc.) as long as the lighting control is performed based on constant current driving.

Power is supplied to the rear ECU 23, the rear lamp lighting control circuit 41, and the LED board 42 from a battery 6 (power storage device) mounted to the vehicle 2. The rear lamp lighting control circuit 41 and the LED board 42 are housed in, for example, a housing (casing) of the rear lamp 40 provided to the vehicle 2.

The rear ECU 23 generates, for example, an instruction on the lighting state (hereinafter, referred to as lighting state instruction) corresponding to the lighting method instruction sent from the central ECU 21 and transmits it to the rear lamp lighting control circuit 41. The rear lamp lighting control circuit 41 controls the lighting of the LEDs mounted to the LED board 42 in response to the lighting state instruction sent from the rear ECU 23. The above lighting state instruction includes, for example, information (parameter) that specifies the lighting state of the LED, such as the value of the current flowing through the LED, the timing at which the LED is turned on, and the speed at which the brightness of the LED changes (for example, the change with time of the duty cycle when PWM control is performed).

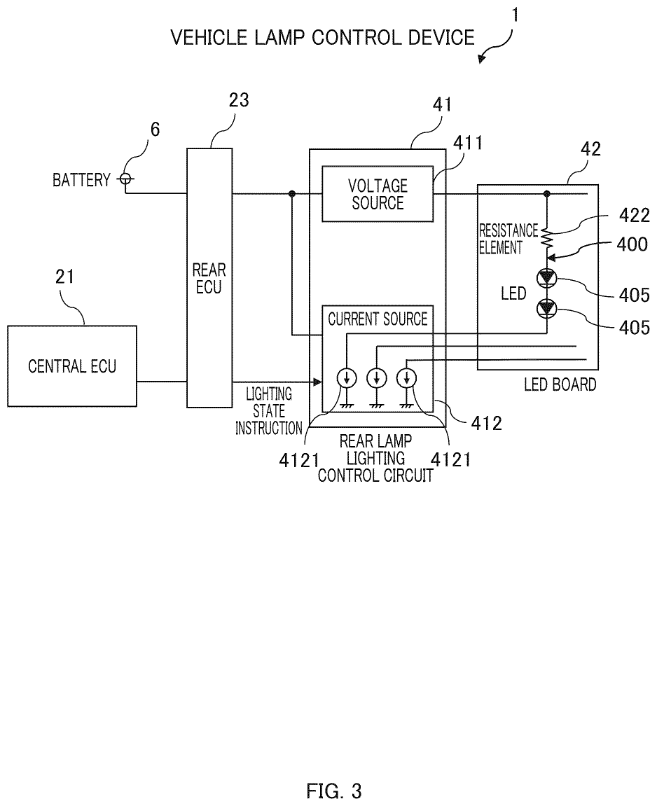

FIG. 3 is a diagram illustrating the rear lamp lighting control circuit 41 and the LED board 42 of a common vehicle lamp control device 1. As illustrated in the figure, the rear lamp lighting control circuit 41 includes a voltage source 411 that applies a driving voltage to one or more LEDs 405 mounted to the LED board 42, and a current source 412 that supplies a constant current to the LEDs 405.

The voltage source 411 is a device that generates a direct-current (DC) voltage of a predetermined magnitude based on the power supplied from the battery 6, and is configured using, for example, a DC/DC converter (step-down converter, step-up converter, step-up/down converter, etc.).

The current source 412 is configured using, for example, an integrated circuit (hereinafter also referred to as “driver IC”) such as a sink driver IC and the like. The current source 412 includes a plurality of constant current sources 4121 capable of individually (independently) controlling the current (constant current) in response to a lighting state instruction.

One or more LED arrays 400 are provided to the LED board 42. One LED array 400 includes one or more LEDs 405 connected in series. The DC voltage having a predetermined magnitude is applied to the LED array 400 from the voltage source 411. One LED array 400 is connected to one of the plurality of constant current sources 4121 included in the current source 412. The LED array 400 includes one or more resistance elements 422 to adjust the voltage applied to the constant current source 4121. The figure illustrates the case where the LED array 400 includes one resistance element 422 and two LEDs 405 connected in series.

### First Embodiment

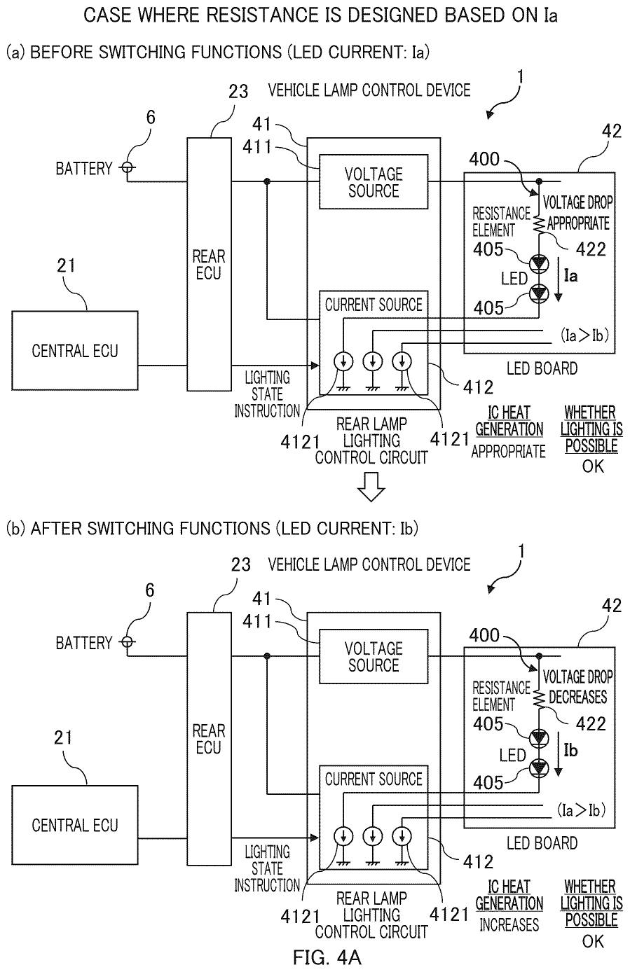

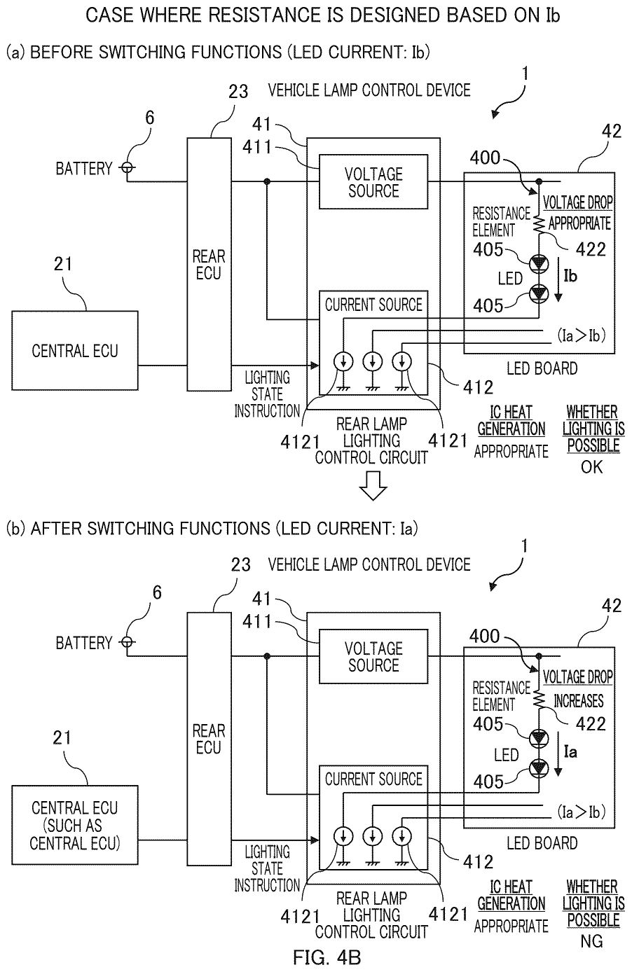

In the configuration illustrated in FIG. 3, for example, when the lighting state of the LED 405 is changed in response to the lighting state instruction from the rear ECU 23, the value of the current flowing through the LED 405 changes, and the voltage (hereinafter referred to as “Vk”) applied to the constant current source 4121 changes. Thus, there is a possibility that power consumption and heat generation may increase due to an excessive voltage (Vk) applied to the constant current source, or that the LED 405 may not light up, for example, due to an excessively low voltage (Vk) applied to the constant current source. Hereinafter, this situation will be specifically described with reference to FIGS. 4A and 4B.

As an example, such a case is considered where the brightness (luminance) of the LED 405 in the LED array 400 is switched from a brightly lit state to a dimly lit state in response to a lighting state instruction sent from the rear ECU 23. Examples of the case where such switching is performed include the case where the LED 405 that has been brightly lit as a stop lamp is to be dimly lit as a tail lamp. Hereinafter, the value of the current flowing through the LED 405 when the LED 405 is brightly lit is la, and the value of the current flowing through the LED 405 when the LED 405 is dimly lit is lb (<la).

Here, for example, as illustrated in FIG. 4A, such a case is considered where the resistance value of the resistance element 422 is designed based on la, that is, the case where the resistance value of the resistance element 422 is designed such that the value of the voltage (Vk) applied to the constant current source 4121 becomes appropriate when a current of la flows through the LED array 400. In this case, as illustrated in FIG. 4A(a), when the LED 405 is brightly lit, that is, when the current value of the LED 405 is la, the voltage drop in the resistance element 422 is appropriate, and the value of the voltage (Vk) applied to the constant current source 4121 is also appropriate. On the other hand, as illustrated in FIG. 4A(b), when the LED 405 is dimly lit, that is, when the current value of the LED 405 is lb, the voltage drop in the resistance element 422 decreases, and as a result, the value of the voltage (Vk) applied to the constant current source 4121 increases (becomes excessively large), leading to an increase in power consumption and heat generation.

Further, for example, as illustrated in FIG. 4B, such a case is considered where the resistance value of the resistance element 422 is designed based on lb, that is, the case where the resistance value of the resistance element 422 is designed such that the voltage applied to the constant current source 4121 becomes appropriate when the current of lb flows through the LED 405. In this case, as illustrated in FIG. 4B, when the LED 405 is dimly lit, that is, when the value of the current flowing through the LED 405 is lb, the voltage drop in the resistance element 422 is appropriate, and the voltage applied to the constant current source 4121 is also appropriate. On the other hand, as illustrated in FIG. 4B, when the LED 405 is brightly lit, that is, when the current flowing through the LED 405 is la, the voltage drop in the resistance element 422 increases, and the value of the voltage (Vk) applied to the constant current source 4121 decreases. When the value of the voltage (Vk) falls below the lower limit of the voltage needed to properly operate the constant current source 4121 (becomes excessively low), the LED 405 does not light up.

As such, when the value of the resistance element 422 is fixed, switching of the lighting state of the LED 405 in response to the lighting state instruction sent from the rear ECU 23 may lead to an increase in power consumption and heat generation in the constant current source 4121 and the LED 405 failing to light up.

Thus, in an embodiment of the present disclosure, such an issue is to be solved by providing a resistance circuit capable of changing the resistance value (hereinafter referred to as “resistance circuit 420”) in the LED array 400. Hereinafter, some configurations of the vehicle lamp control device 1 according to an embodiment of the present disclosure will be specifically described.

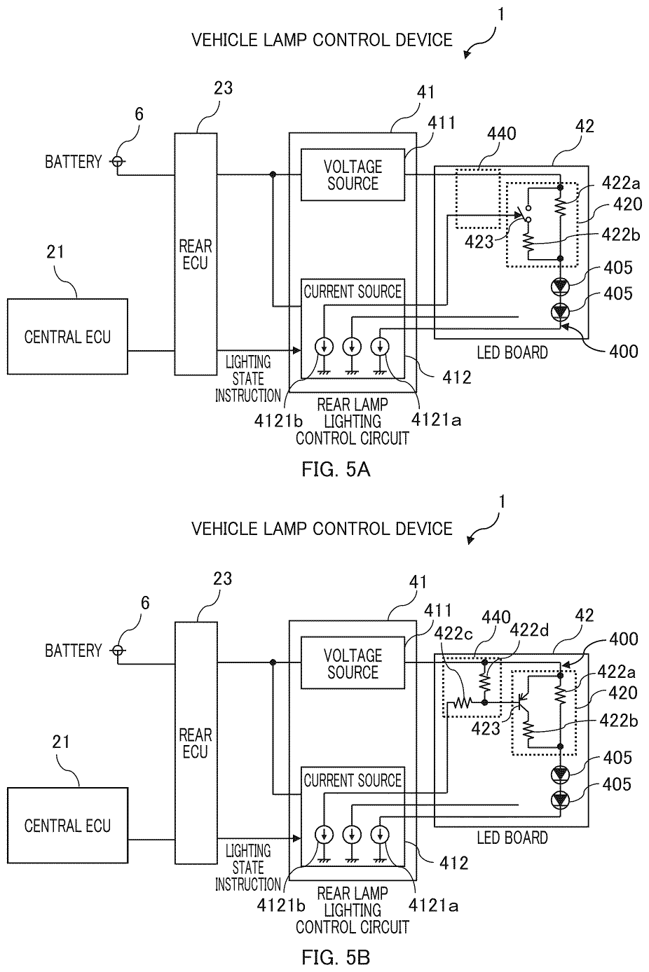

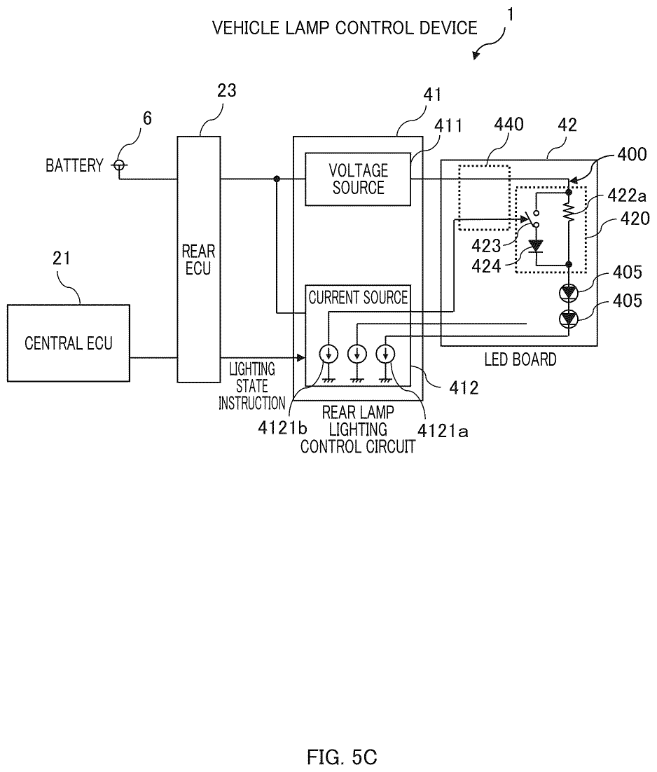

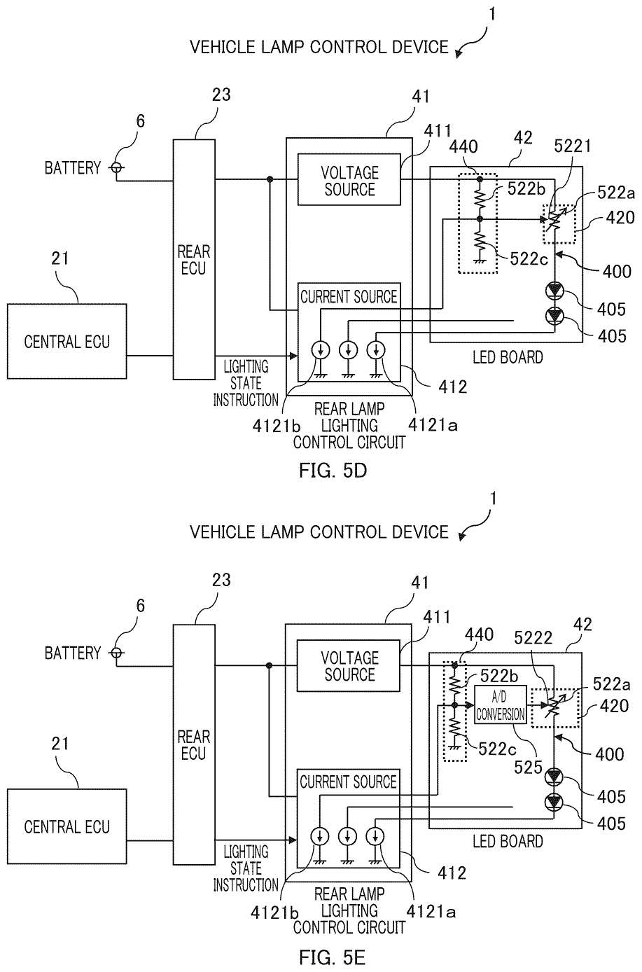

FIG. 5A is a configuration example of the vehicle lamp control device 1 of an embodiment of the present disclosure. In the illustrated vehicle lamp control device 1, a resistance circuit 420 is provided in series with the LED 405 constituting the LED array 400, and a circuit to control the resistance value of the resistance circuit 420 (hereinafter referred to as “resistance value control circuit 440”) is provided. The resistance circuit 420 includes a resistance element 422a, a resistance element 422b connected in parallel to the resistance element 422a, and a switch 423 connected in series to the resistance element 422b, to turn on and off the connection to the LED 405. The specific configuration of the resistance value control circuit 440 will be described later.

In the example of the figure, the on and off of the switch 423 is controlled by changing the current value of another constant current source 4121 (hereinafter also referred to as “second constant current source 4121b”) different from the constant current source 4121 (hereinafter also referred to as “first constant current source 4121a”) that is supplying a current to the LED array 400, among the plurality of constant current sources 4121 included in the current source 412.

The current source 412 controls the on and off of the switch 423 by controlling the current value of the second constant current source 4121b in response to the lighting state instruction from the rear ECU 23, to change the resistance value of the resistance circuit 420.

For example, when the LED 405 is brightly lit in response to the lighting state instruction from the rear ECU 23 (when the current value of the LED 405 increases), the current source 412 turns off the switch 423 by changing the current value of the second constant current source 4121b, to thereby increase the resistance value of the resistance circuit 420 (increase the voltage drop in the resistance circuit 420) and prevent an increase in the voltage applied to the first constant current source 4121a.

Further, for example, when the LED 405 is dimly lit in response to the lighting state instruction from the rear ECU 23 (when the current value of the LED 405 decreases), the current source 412 turns on the switch 423 by changing the current value of the second constant current source 4121b, to thereby decrease the resistance value of the resistance circuit 420 (decrease the voltage drop in the resistance circuit 420) and prevent a decrease in the voltage applied to the first constant current source 4121a.

As such, in the illustrated vehicle lamp control device 1, the resistance value of the resistance circuit 420 is changed so as to suppress a change in the value of the voltage applied to the first constant current source 4121a caused by a change in the value of the current supplied to the LED 405 in response to the lighting state instruction from the rear ECU 23. Thus, for example, even when the lighting of the light source (LED 405) is controlled in various aspects using animation or the like, the value of the voltage applied to the first constant current source 4121a can be maintained within a predetermined range, thereby being able to prevent an increase in power consumption and heat generation caused by an excessively large value of the voltage (Vk) applied to the first constant current source 4121a. In addition, it is possible to prevent the LED 405 from failing to light up due to the value of the voltage (Vk) applied to the first constant current source 4121a falling below the value needed to properly operate the first constant current source 4121a (becoming excessively low).

Further, in the illustrated vehicle lamp control device 1, with the current source 412 changing the current value of the second constant current source 4121b, which is different from the first constant current source 4121a, in the plurality of constant current sources 4121 included in the current source 412, in other words, with the use of the second constant current source 4121b, which is one of the constant current sources 4121 of the current source 412, the resistance value of the resistance circuit 420 is changed. Thus, it is possible to implement, with a simple configuration, a mechanism to control the resistance value of the resistance circuit 420 in response to the lighting state instruction can be implemented.

In addition, a change in the value of the current supplied from the constant current source 4121 to the LED 405 may occur even when updating the software to implement the process of generating the lighting state instruction, which is stored in the rear ECU 23 based on the information received by the rear ECU 23 from the central ECU 21; however, even in that case, the value of the voltage (Vk) applied to the first constant current source 4121a can be maintained within a predetermined range.

FIG. 5B illustrates the case where the switch 423 illustrated in FIG. 5A is configured using a transistor. In this example, the emitter of the transistor is connected to the voltage source 411, and the collector thereof is connected to the resistance element 422b. The base of the transistor is connected to the second constant current source 4121b via the resistance element 422c and to the voltage source 411 via the resistance element 422d. The base of the transistor is applied with a voltage determined by the voltage value of the voltage source 411, the value of the current supplied from the second constant current source 4121b, the resistance value of the resistance element 422c, and the resistance value of the resistance element 422d. That is, in the vehicle lamp control device 1 illustrated in the figure, the resistance value control circuit 440 described above is configured with the resistance element 422c and the resistance element 422d.

In the example of FIG. 5B, the switch 423 is configured using a PNP transistor. Therefore, when the value of the current supplied from the second constant current source 4121b is small and the drop in the voltage at the resistance element 422d is equal to or less than a predetermined value, the switch 423 is off, and when the above current value is large and the drop of the voltage at the resistance element 422d exceeds the predetermined value, the switch 423 is on.

The switch 423 may be configured using another type of element such as, for example, a field-effect transistor (FET). When the switch 423 is configured using a field-effect transistor, the drain thereof is connected to the voltage source 411 and the source thereof is connected to the resistance element 422b. The gate thereof is connected to the second constant current source 4121b via the resistance element 422c and to the voltage source 411 via the resistance element 422d.

As such, the on and off of the switch 423 can be controlled by changing the value of the current supplied from the second constant current source 4121b. A mechanism to control the resistance value of the resistance circuit 420 in response to the lighting state instruction can be simply configured using a resistance element and the switch 423.

FIG. 5C is another configuration example of the vehicle lamp control device 1. In this example, the resistance element 422b connected in series to the switch 423 of the resistance circuit 420 in FIG. 5B is replaced with a diode 424 connected in the forward direction to the LED array 400. The resistance value of the resistance circuit 420 when the switch 423 is off is the resistance value of the resistance element 422a. When the switch 423 is on, the resistance value of the resistance circuit 420 reaches zero. To cause the resistance value of the resistance circuit 420 to be a predetermined value other than zero even when the switch 423 is on, for example, a resistance element only have to be connected in series to the switch 423. Although a specific configuration is omitted in the figure, for example, the circuit illustrated in FIG. 5B (circuit configured with the resistance element 422c and the resistance element 422d) can be used as the resistance value control circuit 440 with respect to the resistance circuit 420.

FIG. 5D is another configuration example of the vehicle lamp control device 1. In this example, the resistance value of the resistance circuit 420 connected to the LED array 400 is changed by a variable resistance element 522a connected in series to the LED array 400. This example uses, as the variable resistance element 522a, a potentiometer of a type in which the resistance value is set with an analog value (voltage value) (hereinafter referred to as “analog potentiometer”).

As illustrated in the figure, the analog value input terminal 5221 of the variable resistance element 522a is connected to the second constant current source 4121b. A voltage obtained by dividing the voltage of the voltage source 411 by the resistance value of the resistance element 522b and the resistance value of the resistance element 522c is applied to the input terminal 5221. The resistance value of the resistance element 522b and the resistance value of the resistance element 522c are each set according to, for example, the range of the resistance value needed for the resistance circuit 420. In the case of this circuit, the resistance value control circuit 440 is configured with the resistance element 522b and the resistance element 522c.

The vehicle lamp control device 1 illustrated in FIG. 5E is the case where the resistance value of the resistance circuit 420 connected to the LED array 400 is changed by the variable resistance element 522a connected in series to the LED array 400, as in FIG. 5D. This example uses, as the variable resistance element 522a, a potentiometer of a type in which the resistance value is set by inputting a digital value specifying the resistance value (hereinafter referred to as “digital potentiometer”).

In this example, the analog voltage value obtained by voltage division by the resistance element 522b and the resistance element 522c is converted into a digital value by the A/D conversion circuit 525, and the converted digital value is inputted to the digital value input terminal 5222 of the variable resistance element 522a. In the case of this circuit, the resistance value control circuit 440 is configured with the resistance element 522b, the resistance element 522c, and the A/D conversion circuit 525.

As such, a mechanism to change the resistance value of the resistance element 422 connected to the LED array 400 in response to the lighting state instruction from the rear ECU 23 can be simply configured using a variable resistance element such as an analog potentiometer or a digital potentiometer. When a digital potentiometer is used as the variable resistance element 522a, the advantages of the digital potentiometer (high precision, high resolution, small size, high stability, long life, high reliability, etc.) can be enjoyed.

Further, in the configurations illustrated in FIGS. 5A to 5C described above, since the resistance values of the resistance element 422a and the resistance element 422b are fixed, the resistance value of the resistance circuit 420 can only be changed in a stepwise manner (discontinuously). On the other hand, in the configuration illustrated in FIG. 5D or FIG. 5E, since a variable resistance element is used, the resistance value of the resistance circuit 420 can be changed continuously. Therefore, the value of the resistance circuit 420 can be finely controlled, and for example, when the lighting state of the light-emitting element is finely controlled as in the case of displaying animation, it is possible to cause the resistance value of the resistance circuit 420 to follow the change in the lighting state of the light-emitting element with accuracy.

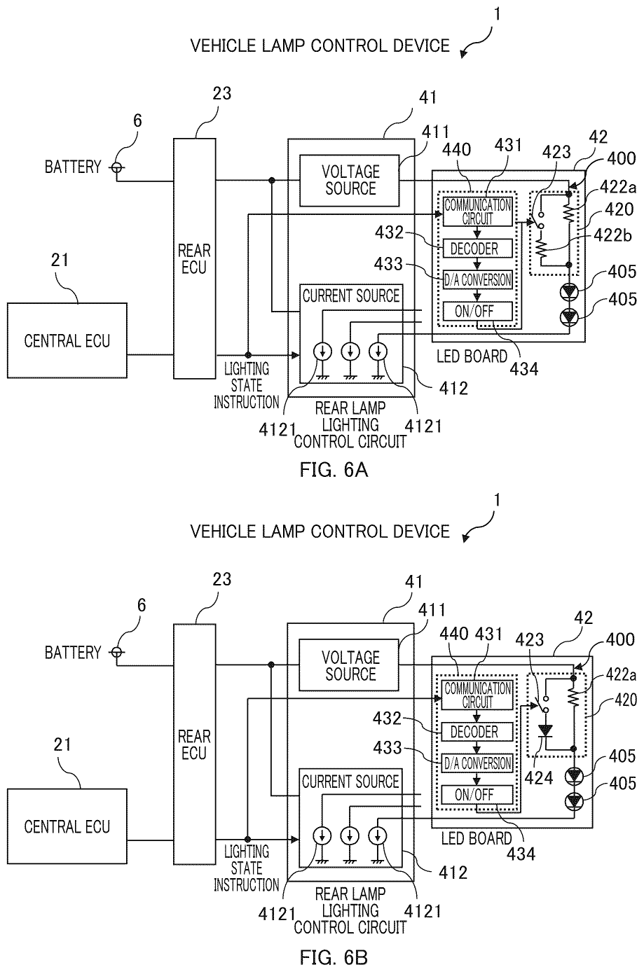

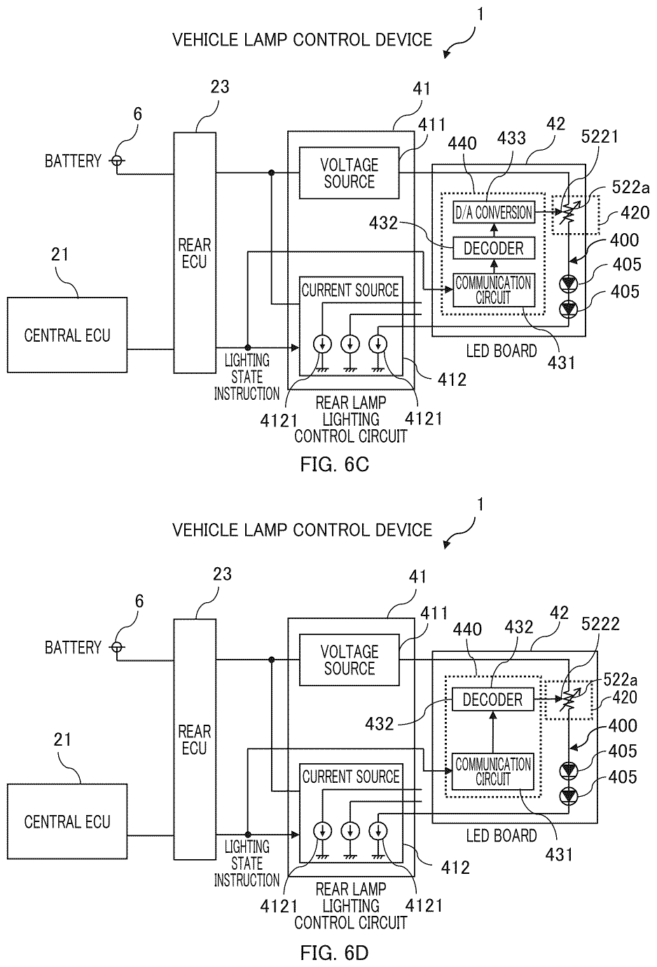

FIGS. 6A to 6D are other configuration examples of the vehicle lamp control device 1. In the vehicle lamp control devices 1 illustrated in FIGS. 5A to 5E, the resistance value of the resistance circuit 420 is changed using the constant current source 4121 (second constant current source 4121b) of the current source 412. On the other hand, in the vehicle lamp control devices 1 illustrated in FIGS. 6A to 6D, the LED board 42 has a communication function, the LED board 42 receives the lighting state instruction from the rear ECU 23, and the LED board 42 controls the switch to change the resistance value of the resistance circuit 420, in response to the received lighting state instruction.

The resistance circuit 420 in the vehicle lamp control device 1 illustrated in FIG. 6A is, for example, the same as that illustrated in FIG. 5A or FIG. 5B. In this example, the LED board 42 is provided with a communication circuit 431 (CAN transceiver, etc.) that receives the lighting state instruction, a decoder circuit 432 that decodes the lighting state instruction, a D/A conversion circuit 433 that converts the decoded digital value into an analog value, and an on-off control circuit 434 that controls the switch 423 based on the converted analog value.

The lighting state instruction received by the communication circuit 431 includes, for example, a parameter for giving an instruction to turn on or off the switch 423. The D/A conversion circuit 433 generates an analog value according to the value of the above parameter and inputs it to the on-off control circuit 434. In the example of the figure, the resistance value control circuit 440 is configured with the communication circuit 431, the decoder circuit 432, the D/A conversion circuit 433, and the on-off control circuit 434.

As such, a mechanism to change the resistance value of the resistance circuit 420 in response to the lighting state instruction from the rear ECU 23 can also be implemented with the configuration illustrated in the figure. In the case of such a configuration, the above mechanism can be implemented without consuming the resources (constant current source) of the current source 412.

In FIG. 6B, as in the case of the vehicle lamp control device 1 illustrated in FIG. 5C, the resistance element 422b of the resistance circuit 420 in FIG. 6A is replaced with the diode 424 connected in the forward direction. In this example, the resistance value of the resistance circuit 420 when the switch 423 is on can be made substantially zero. For example, with the resistance element 422b having a resistance value greater than zero being connected in series to the switch 423, it is possible to cause the resistance value of the resistance circuit 420 when the switch 423 is on to be a predetermined value greater than zero. In the example of the figure, the resistance value control circuit 440 is configured with the communication circuit 431, the decoder circuit 432, the D/A conversion circuit 433, and the on-off control circuit 434.

In FIGS. 6C and 6D, as in the vehicle lamp control devices 1 illustrated in FIGS. 5D and 5E, the resistance circuit 420 is configured using the variable resistance element 522a.

FIG. 6C illustrates the case where an analog potentiometer is used as the variable resistance element 522a, as in FIG. 5D. In this example, the LED board 42 is provided with the communication circuit 431 (CAN transceiver, etc.) that receives the lighting state instruction, the decoder circuit 432 that decodes the lighting state instruction, and the D/A conversion circuit 433 that converts the decoded digital value into an analog value and inputs a result to the analog value input terminal 5221 of the variable resistance element 522a. In the example of the figure, the resistance value control circuit 440 is configured with the communication circuit 431, the decoder circuit 432, and the D/A conversion circuit 433.

FIG. 6D illustrates the case where a digital potentiometer is used as the variable resistance element 522a, as in FIG. 5E. In this example, the LED board 42 is provided with the communication circuit 431 (CAN transceiver, etc.) that receives the lighting state instruction, and the decoder circuit 432 that decodes the lighting state instruction and inputs the decoded digital value to the digital value input terminal 5222 of the variable resistance element 522a. In the example of the figure, the resistance value control circuit 440 is configured with the communication circuit 431 and the decoder circuit 432.

As such, the vehicle lamp control device 1 of an embodiment of the present disclosure changes the resistance value of the resistance circuit 420 so as to suppress a change in the value of the voltage (Vk) applied to the first constant current source 4121a when the value of the current supplied to the LED 405 changes. Thus, for example, even when the lighting of the LED 405 is controlled in various aspects using animation or the like, the value of the voltage applied to the first constant current source 4121a can be maintained within a predetermined range. Accordingly, it is possible to prevent an increase in power consumption and heat generation caused by an excessively large value of the voltage (Vk) applied to the first constant current source 4121a, and to prevent the LED 405 from failing to light up due to the value of the voltage (Vk) applied to the first constant current source 4121a falling below the value needed to properly operate the first constant current source 4121a (becoming excessively low).

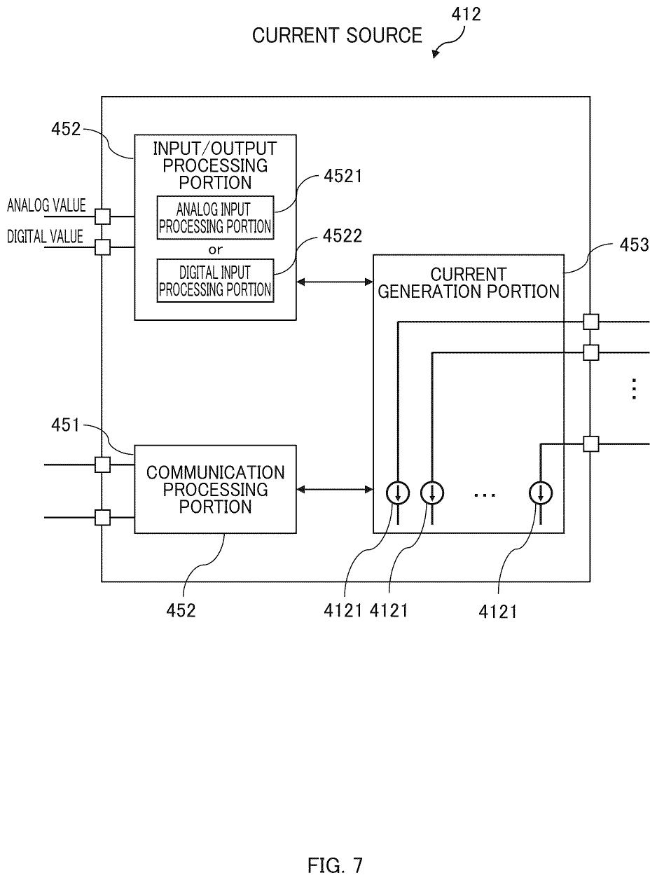

FIG. 7 is a block diagram illustrating a configuration example of the current source 412. The illustrated current source 412 is configured using, for example, a sink driver IC. As illustrated in the figure, the illustrated current source 412 includes a communication processing portion 451, an input/output processing portion 452, and a current generation portion 453.

The communication processing portion 451 functions as, for example, a CAN transceiver. The communication processing portion 451 communicates with the rear ECU 23, such as receiving information (lighting state instruction, etc.) sent from the rear ECU 23. For example, the current generation portion 453 is notified of the information received by the communication processing portion 451 from the rear ECU 23.

The input/output processing portion 452 includes an analog input processing portion 4521 and a digital input processing portion 4522. The analog input processing portion 4521 receives an analog value inputted from the outside and notifies the current generation portion 453 of the received analog value. The digital input processing portion 4522 receives a digital value inputted from the outside and notifies the current generation portion 453 of the received digital value.

The current generation portion 453 controls the value of the current outputted from the constant current source 4121 based on the information (lighting state instruction, etc.) received from the communication processing portion 451 and the information received from the input/output processing portion 452.

Although embodiments of the present disclosure have been described in detail above, the present disclosure is not limited to the above embodiments, and various modifications are included. Further, the above embodiments have described the configurations in detail in order to explain the present disclosure in an easy-to-understand manner, and are not necessarily limited to those including all the configurations described. Further, it is possible to add, delete, or replace a part of a configuration of the embodiments described above.

For example, the above description has focused on one LED array 400 provided to the LED board 42, but when a plurality of LED arrays 400 are provided to the LED board 42, the configuration described above may be applied to each of the LED arrays 400.

As such, the vehicle lamp control device 1 of an embodiment of the present disclosure includes a first constant current source configured to supply a constant current to a light-emitting element used in a vehicle lamp, a resistance circuit connected in series to the light-emitting element and the first constant current source, a current value control circuit configured to control the current value of the first constant current source in response to a lighting state instruction to instruct the lighting state of the light-emitting element, and a resistance value control circuit configured to change the resistance value of the resistance circuit so as to suppress a change in the value of the voltage applied to the first constant current source when the value of the current supplied to the light-emitting element changes.

According to the above configuration, the resistance value of the resistance circuit can be changed so as to suppress the change in the value of the voltage applied to the first constant current source when the value of the current supplied to the light-emitting element changes; for example, even when the lighting of the light-emitting element of the vehicle lamp is controlled in various aspects using animation and the like, the value of the voltage applied to the first constant current source can be maintained in a predetermined range. Accordingly, it is possible to prevent power consumption and heat generation from an increasing and the light-emitting element from failing to light up, which are caused by the value of the voltage applied to the first constant current source becoming excessively large or excessively small.

Further, the vehicle lamp control device 1 of an embodiment of the present disclosure further includes a second constant current source configured to supply a current in response to the lighting state instruction, and the resistance value control circuit changes the resistance value of the resistance circuit according to the value of the current supplied by the second constant current source.

As such, the vehicle lamp control device 1 changes the resistance value of the resistance circuit by using a constant current source (second constant current source) included in a current source having a plurality of constant current sources, thereby being able to implement, with a simple configuration, a mechanism to control the resistance value of the resistance circuit in response to the lighting state instruction.

Further, the above resistance circuit of the vehicle lamp control device 1 of an embodiment of the present disclosure includes a first resistance element that is connected in series to the light-emitting element, and a second resistance element and a switch that are connected in series to the light-emitting element and connected in parallel to the first resistance element, and the resistance value control circuit turns on and off the switch according to the current value of the second constant current source.

According to the above configuration, it is possible to implement, with a simple configuration, a mechanism to control the resistance value of the resistance circuit in response to the lighting state instruction.

Further, the resistance circuit of the vehicle lamp control device 1 of an embodiment of the present disclosure includes a first resistance element that is connected in series to the light-emitting element, and a diode and a switch that are connected in series to the light-emitting element in a forward direction and connected in parallel to the first resistance element, and the resistance value control circuit turns on and off the switch according to the current value of the second constant current source.

According to the above configuration, it is possible to implement, with a simple configuration, a mechanism to control the resistance value of the resistance circuit according to a change in the temperature of the light-emitting element. It is also possible to cause the resistance value of the resistance circuit to be zero by electrically connecting the diode.

Further, the above resistance circuit of the vehicle lamp control device 1 of an embodiment of the present disclosure includes a variable resistance element whose resistance value changes according to a control voltage, and the resistance value control circuit outputs the control voltage according to the current value of the second constant current source.

As such, with the use of the variable resistance element, it is possible to implement, with a simple configuration, a mechanism to change the resistance value of the resistance circuit in response to the lighting state instruction.

Further, the first constant current source and the second constant current source of the vehicle lamp control device 1 according to an embodiment of the present disclosure are constant current sources different from each other among a plurality of constant current sources included in one integrated circuit.

Thus, a mechanism to change the resistance value of the resistance circuit in response to the lighting state instruction can be implemented with a simple configuration using one integrated circuit including a plurality of constant current sources, such as a driver IC or the like.

Further, the vehicle lamp control device 1 of an embodiment of the present disclosure further includes a receiving circuit configured to receive the lighting state instruction from another device communicably connected thereto, and the resistance value control circuit changes the resistance value of the resistance circuit in response to the lighting state instruction received by the receiving circuit.

As such, according to the above configuration, another device such as the rear ECU or the like directly controls the resistance value of the resistance circuit, and thus a mechanism to change the resistance value of the resistance circuit in response to the lighting state instruction can be implemented without consuming the resources (constant current source) of the current source (driver IC).

Further, the above resistance circuit of the vehicle lamp control device 1 of an embodiment of the present disclosure includes a first resistance element that is connected in series to the light-emitting element, and a second resistance element and a switch that are connected in series to the light-emitting element and in parallel to the first resistance element, and the resistance value control circuit turns on and off the switch in response to the lighting state instruction.

According to the above configuration, a mechanism to control the resistance value of the resistance circuit in response to the lighting state instruction can be implemented with a simple configuration.

Further, the vehicle lamp control device 1 of an embodiment of the present disclosure includes a second information processing device communicably connected to a first information processing device, and the second information processing device stores software to implement the process of generating the lighting state instruction, receives update information of the software from the first information processing device, and updates the software to the contents for causing the value of the current supplied to the light-emitting element to change before and after the update, based on the received update information.

The change in the value of the current supplied to the light-emitting element also occurs when updating the software to implement the process of generating the lighting state instruction, which is stored in the second information processing device based on the information received from the first information processing device. According to the above configuration, even in such a case, the value of the voltage applied to the first constant current source can be maintained within a predetermined range.

### Second Embodiment

In the configuration illustrated in FIG. 3, when the temperature of the LED 405 changes and the value of the voltage (hereinafter referred to as “Vk”) applied to the constant current source changes, the value of the voltage (Vk) applied to the constant current source may become excessively large, which may result in an increase in power consumption and heat generation, or the value of the voltage (Vk) applied to the constant current source may become excessively small, which may result in the LED 405 failing to light up.

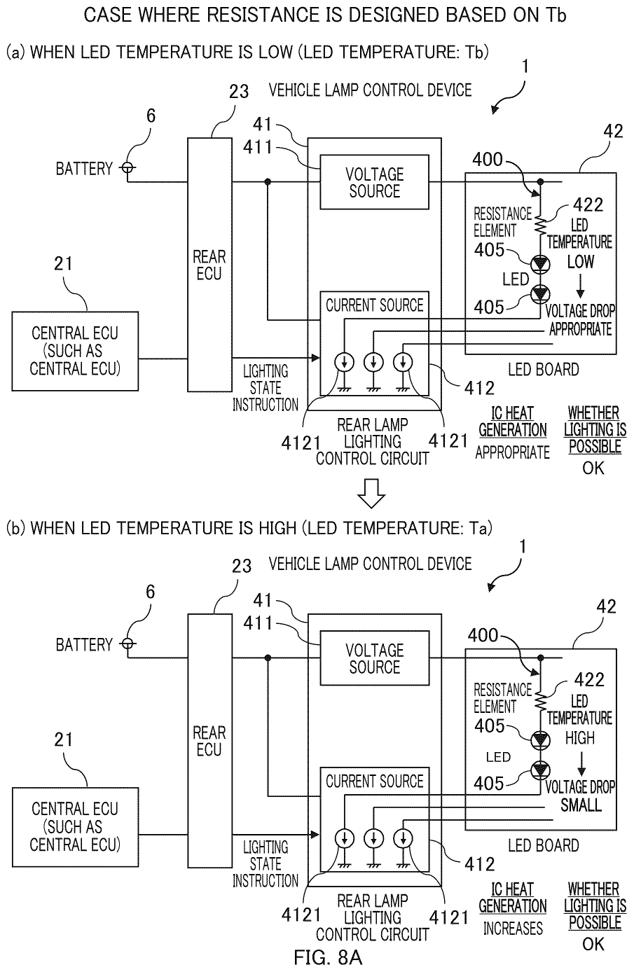

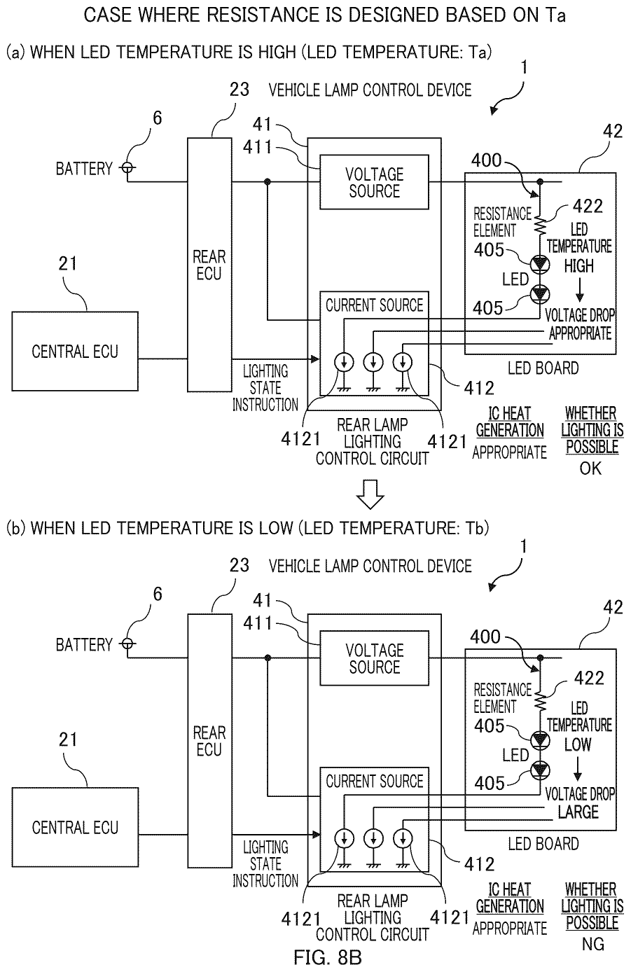

Note that the temperature of the LED 405 changes, for example, when the ambient temperature changes or when the value of the current supplied to the LED 405 changes due to the method of lighting the LED 405 is changed in response to the lighting state instruction from the rear ECU 23. The following specifically describes, with reference to FIGS. 8A and 8B, the situation where a change in the temperature of the LED 405 results in an increase in power consumption and heat generation and/or failing to light. As an example, such a case is considered where the temperature of the LED 405 rises (the temperature of the LED 405 rises from a low temperature (Tb) to a high temperature (Ta (>Tb))).

Here, for example, as illustrated in FIG. 8A, such a case is considered where the resistance value of the resistance element 422 of the LED board 42 is designed based on the low temperature (Tb), in other words, the case where the value of the resistance element 422 is designed such that the value of the voltage (Vk) of the constant current source 4121 will be appropriate when the temperature of the LED 405 is the low temperature (Tb). In this case, as illustrated in FIG. 8A(a), when the temperature of the LED 405 is the low temperature (Tb), the voltage drop of the LED 405 will be appropriate, and the value of the voltage (Vk) applied to the constant current source 4121 will also be appropriate. On the other hand, as illustrated in FIG. 8A(b), when the temperature of the LED 405 rises to the high temperature (Ta), the voltage drop of the LED 405 decreases, resulting in the value of the voltage (Vk) applied to the constant current source 4121 rising (becoming excessively large), leading to an increase in power consumption and heat generation.

Further, for example, as illustrated in FIG. 8B, such a case is considered where the resistance value of the resistance element 422 of the LED board 42 is designed based on the high temperature (Ta), in other words, the case where the value of the resistance element 422 is designed such that the voltage value (Vk) of the constant current source 4121 will be appropriate when the temperature of the LED 405 is the high temperature (Ta). In this case, as illustrated in FIG. 8B(a), when the temperature of the LED 405 is the high temperature (Ta), the voltage drop of the LED 405 will be appropriate, and the value of the voltage (Vk) applied to the constant current source 4121 will also be appropriate. On the other hand, as illustrated in FIG. 8B(b), when the temperature of the LED 405 decreases to the low temperature (Tb), the voltage drop of the LED 405 will increase, resulting in a reduction in the value of the voltage (Vk) applied to the constant current source 4121. Then, when the value of the voltage (Vk) falls below the lower limit of the voltage needed to properly operate the constant current source 4121 (becomes excessively low), the LED 405 fails to light up.

As such, when the value of the resistance element 422 is fixed, a change in the temperature of the LED 405 may lead to an increase in power consumption and heat generation in the constant current source 4121 or to the LED 405 failing to light up.

Thus, in an embodiment of the present disclosure, such an issue is solved by providing a resistance circuit (hereinafter referred to as “resistance circuit 420”) capable of changing the resistance value to the LED array 400. The following specifically describes some configurations of the vehicle lamp control device 1 of an embodiment of the present disclosure.

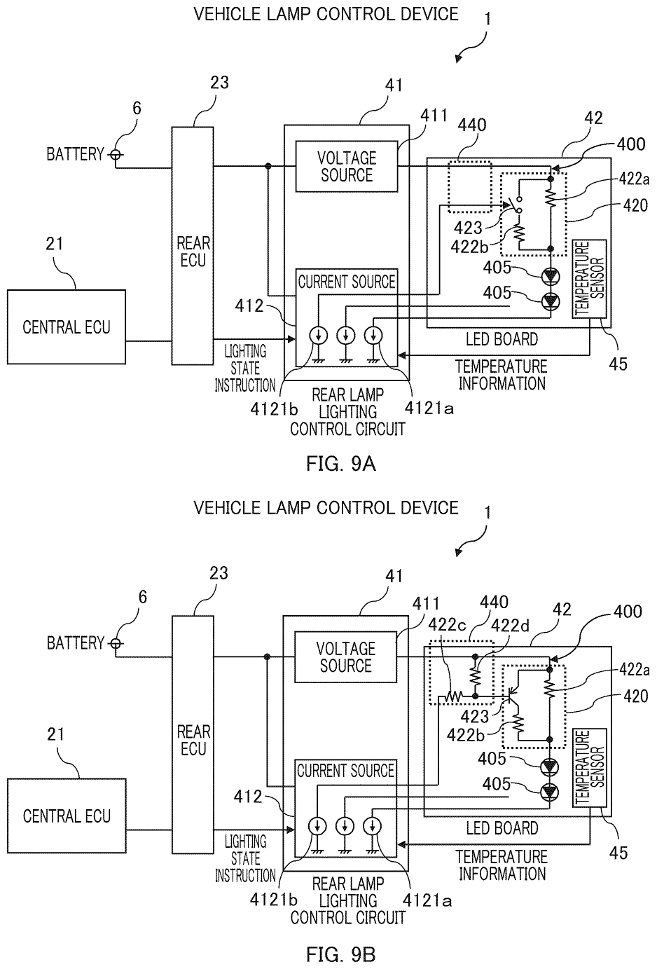

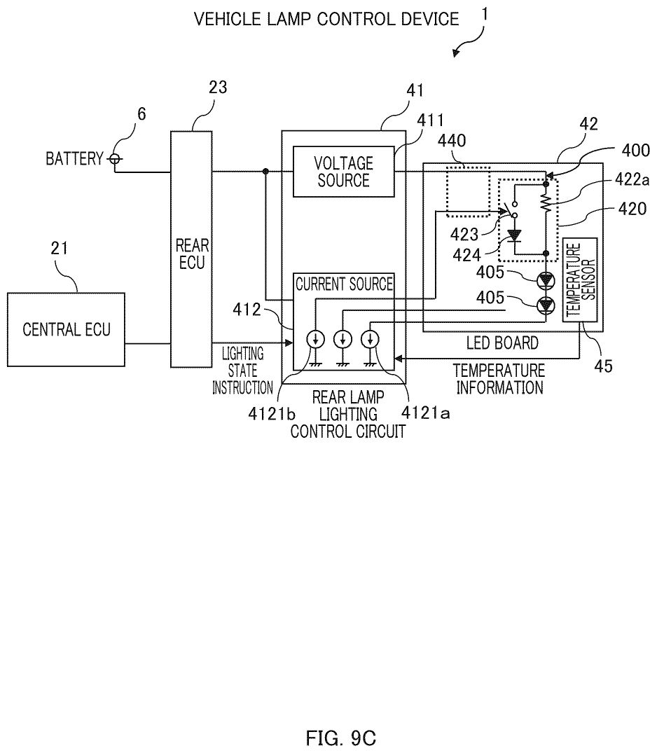

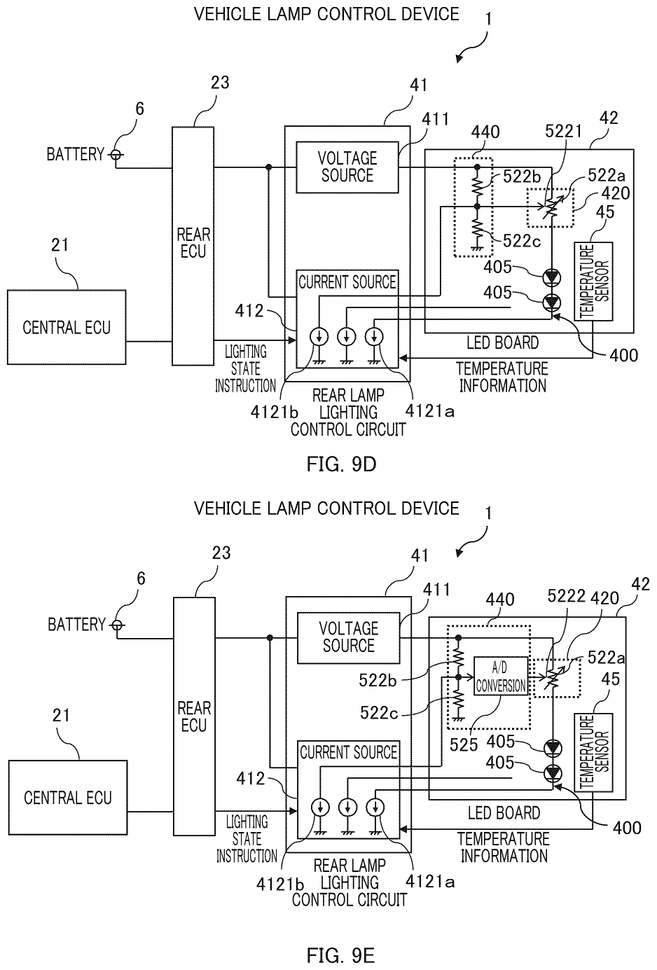

FIG. 9A is a configuration example of the vehicle lamp control device 1 of an embodiment of the present disclosure. In the illustrated vehicle lamp control device 1, a resistance circuit 420 is provided in series with the LED 405 constituting the LED array 400, and a circuit (hereinafter referred to as “resistance value control circuit 440”) that controls the resistance value of the resistance circuit 420 is provided. The resistance circuit 420 includes the resistance element 422a, the resistance element 422b connected in parallel to the resistance element 422a, and the switch 423 connected in series to the resistance element 422b, to turn on and off the connection to the LED 405. The specific configuration of the resistance value control circuit 440 will be described later.

A temperature sensor 45 that acquires information (hereinafter referred to as “temperature information”) indicating the temperature around the LED 405 is provided at a predetermined position in the LED board 42. The notification (input) of temperature information acquired (measured) by the temperature sensor 45 is provided to the current source 412 of the rear lamp lighting control circuit 41 via a circuit such as wiring or a communication line. The temperature information does not necessarily have to be the temperature of the element of the LED 405 itself, but may be information capable of indirectly specifying or estimating the temperature of the LED 405, such as the temperature around the LED 405. For example, the temperature information may be acquired by other types of sensors based on other principles, such as optical sensors, total radiation thermometers, optical pyrometers, infrared thermometers, and the like.

In the example of the figure, the on and off of the switch 423 is controlled by changing the current value of another constant current source 4121 (hereinafter also referred to as “second constant current source 4121b”) different from the constant current source 4121 (hereinafter also referred to as “first constant current source 4121a”) that is supplying a current to the LED array 400 among the plurality of constant current sources 4121 included in the current source 412.

The current source 412 controls the on and off of the switch 423 by controlling the current value of the second constant current source 4121b based on the received temperature information, to change the resistance value of the resistance circuit 420.

For example, when the temperature of the LED 405 is high, the current source 412 turns off the switch 423 by changing the current value of the second constant current source 4121b to increase the resistance value of the resistance circuit 420 (increase the voltage drop in the resistance circuit 420) and prevent an increase in the voltage applied to the first constant current source 4121a.

Further, for example, when the temperature of the LED 405 is low, the current source 412 turns on the switch 423 by changing the current value of the second constant current source 4121b to decrease the resistance value of the resistance circuit 420 (decrease the voltage drop in the resistance circuit 420) and prevent a decrease in the voltage applied to the first constant current source 4121a.

The boundary value (threshold value) used for determining whether the temperature of the LED 405 is high or low is set according to, for example, the characteristics of the LED 405, the characteristics of the current source 412 (constant current source 4121), and the like.

As such, in the illustrated vehicle lamp control device 1, the resistance value of the resistance circuit 420 is changed so as to suppress a change in the value of the voltage applied to the first constant current source 4121a caused by a change in the temperature of the LED 405 is suppressed. Thus, even when the temperature of the LED 405 changes, the value of the voltage applied to the first constant current source 4121a can be maintained within a predetermined range. Accordingly, it is possible to prevent an increase in power consumption and heat generation caused by an excessively large value of the voltage (Vk) applied to the first constant current source 4121a. In addition, it is possible to prevent the LED 405 from failing to light up due to the value of the voltage (Vk) applied to the first constant current source 4121a falling below the value needed to properly operate the first constant current source 4121a (becoming excessively low).

Further, in the illustrated vehicle lamp control device 1, the current source 412 changes the current value of the second constant current source 4121b, which is different from the first constant current source 4121a, among the plurality of constant current sources 4121 included in the current source 412, in other words, changes the resistance value of the resistance circuit 420 by using the second constant current source 4121b, which is one of the constant current sources 4121 of the current source 412. Thus, a mechanism to control the resistance value of the resistance circuit 420 in response to the lighting state instruction can be implemented with a simple configuration.

FIG. 9B is the case where the switch 423 illustrated in FIG. 9A is configured using a transistor. In this example, the emitter of the transistor is connected to the voltage source 411, and the collector thereof is connected to the resistance element 422b. The base of the transistor is connected to the second constant current source 4121b via the resistance element 422c and to the voltage source 411 via the resistance element 422d. The base of the transistor is applied with a voltage determined by the voltage value of the voltage source 411, the value of the current supplied from the second constant current source 4121b, the resistance value of the resistance element 422c, and the resistance value of the resistance element 422d. That is, in the example of the figure, the resistance value control circuit 440 is configured with the resistance element 422c and the resistance element 422d.

In the example of FIG. 9B, the switch 423 is configured using a PNP transistor. Thus, when the value of the current supplied from the second constant current source 4121b is small and the voltage drop in the resistance element 422d is equal to or less than a predetermined value, the switch 423 is off, and when the current value is large and the voltage drop in the resistance element 422d exceeds the predetermined value, the switch 423 is on.

The switch 423 may be configured using another type of an element such as, for example, a field-effect transistor (FET). When the switch 423 is configured using a field-effect transistor, the drain thereof is connected to the voltage source 411 and the source thereof is connected to the resistance element 422b. The gate thereof is connected to the second constant current source 4121b via the resistance element 422c and to the voltage source 411 via the resistance element 422d.

As such, the on and off of the switch 423 can be controlled by changing the value of the current supplied from the second constant current source 4121b. Further, a mechanism to control the resistance value of the resistance circuit 420 according to the temperature information can be simply configured using a resistance element and the switch 423.

FIG. 9C is another configuration example of the vehicle lamp control device 1. In this example, the resistance element 422b connected in series to the switch 423 of the resistance circuit 420 in FIG. 9B is replaced with the diode 424 connected in the forward direction to the LED array 400. The resistance value of the resistance circuit 420 when the switch 423 is off is the resistance value of the resistance element 422a. Further, when the switch 423 is on, the resistance value of the resistance circuit 420 reaches zero. To cause the resistance value of the resistance circuit 420 to be a predetermined value other than zero even when the switch 423 is on, for example, a resistance element may be connected in series to the switch 423. Although a specific configuration is omitted in the figure, for example, the circuit illustrated in FIG. 9B (circuit configured with the resistance element 422c and the resistance element 422d) can be used as the resistance value control circuit 440 with respect to the resistance circuit 420.

FIG. 9D is another configuration example of the vehicle lamp control device 1. In this example, the resistance value of the resistance circuit 420 connected to the LED array 400 is changed by the variable resistance element 522a connected in series to the LED array 400. This example uses, as the variable resistance element 522a, a potentiometer of a type in which the resistance value is set with an analog value (voltage value) (hereinafter referred to as “analog potentiometer”).

As illustrated in the figure, the analog value input terminal 5221 of the variable resistance element 522a is connected to the second constant current source 4121b. A voltage obtained by dividing the voltage of the voltage source 411 by the resistance value of the resistance element 522b and the resistance value of the resistance element 522c is applied to the input terminal 5221. The resistance value of the resistance element 522b and the resistance value of the resistance element 522c are each set according to, for example, the range of the resistance value needed for the resistance circuit 420. In the case of this circuit, the resistance value control circuit 440 is configured with the resistance element 522b and the resistance element 522c.

The vehicle lamp control device 1 illustrated in FIG. 9E is, as in FIG. 9D, the case where the resistance value of the resistance circuit 420 connected to the LED array 400 is changed by the variable resistance element 522a connected in series to the LED array 400. This example use, as the variable resistance element 522a, a potentiometer of a type in which the resistance value is set by inputting a digital value specifying the resistance value (hereinafter referred to as “digital potentiometer”).

In this example, the analog voltage value obtained by voltage division by the resistance element 522b and the resistance element 522c is converted into a digital value by the A/D conversion circuit 525, and the converted digital value is inputted to the digital value input terminal 5222 of the variable resistance element 522a. In the case of this circuit, the resistance value control circuit 440 is configured with the resistance element 522b, the resistance element 522c, and the A/D conversion circuit 525.

As such, a mechanism to change the resistance value of the resistance circuit 420 according to the short-circuit information can be simply configured using a variable resistance element such as an analog potentiometer or a digital potentiometer. When a digital potentiometer is used as the variable resistance element 522a, the advantages of the digital potentiometer (high precision, high resolution, small size, high stability, long life, high reliability, etc.) can be enjoyed.

Further, in the configurations illustrated in FIGS. 9A to 9C described above, since the resistance values of the resistance element 422a and the resistance element 422b are fixed, the resistance value of the resistance circuit 420 can only be changed in a stepwise manner (discontinuously). On the other hand, in the configuration illustrated in FIG. 9D or FIG. 9E, since a variable resistance element is used, the resistance value of the resistance circuit 420 can be changed continuously. Thus, the value of the resistance circuit 420 can be finely controlled according to the temperature information.

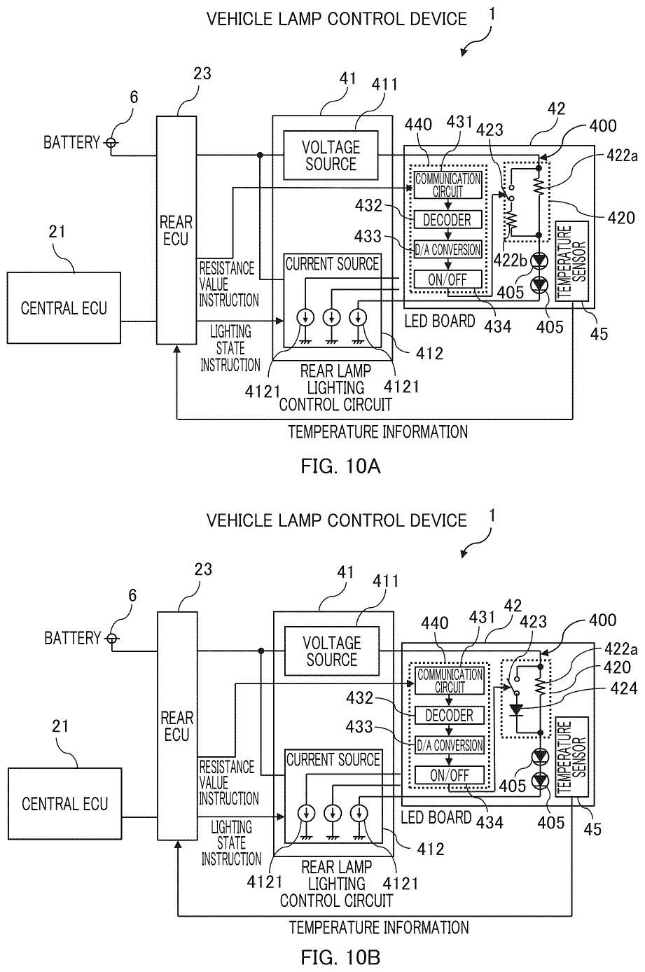

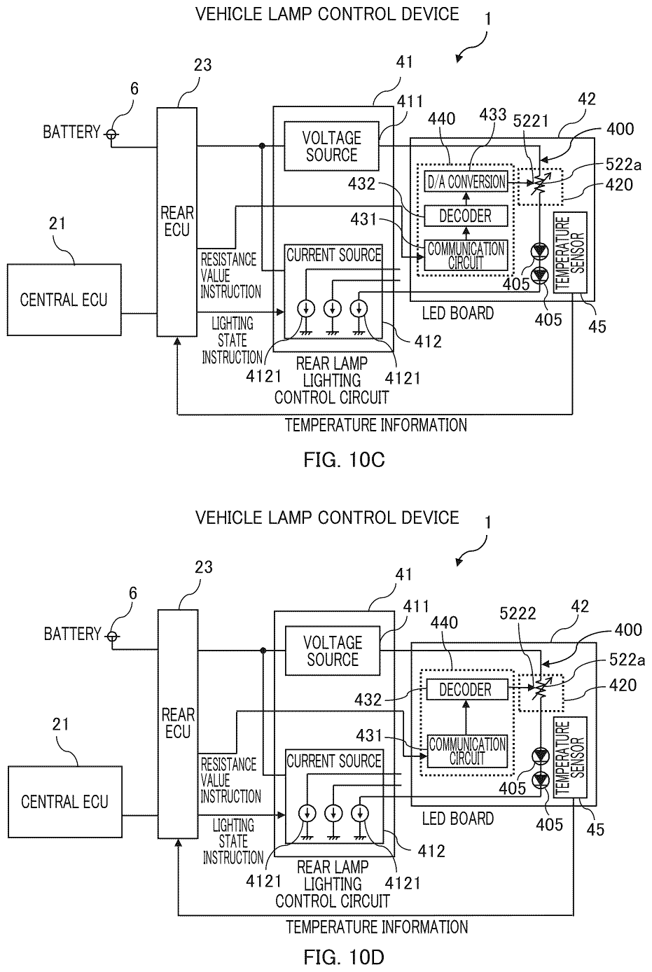

FIGS. 10A to 10D are other configuration examples of the vehicle lamp control device 1. In the vehicle lamp control devices 1 illustrated in FIGS. 9A to 9E, the resistance value of the resistance circuit 420 is changed using the constant current source 4121 (second constant current source 4121b) of the current source 412. On the other hand, in the vehicle lamp control devices 1 illustrated in FIGS. 10A to 10D, the temperature sensor 45 of the short-circuit information acquisition portion 4125 of the rear lamp lighting control circuit 41 notifies the rear ECU 23 of the acquired temperature information, and the rear ECU 23 transmits an instruction (hereinafter referred to as “resistance value instruction”) to change the resistance value of the resistance circuit 420 to the LED board 42 based on the received temperature information. The LED board 42 changes the resistance value of the resistance circuit 420 in response to the resistance value instruction received from the rear ECU 23.

The resistance circuit 420 in the vehicle lamp control device 1 illustrated in FIG. 10A is, for example, the same as that illustrated in FIG. 9A or FIG. 9B. As illustrated in the figure, a notification of the temperature information acquired (measured) by the temperature sensor 45 is provided to the rear ECU 23 via a circuit such as wiring or a communication line, for example. In this example, the LED board 42 is provided with the communication circuit 431 (CAN transceiver, etc.) that receives the lighting state instruction, the decoder circuit 432 that decodes the received lighting state instruction, the D/A conversion circuit 433 that converts the decoded digital value into an analog value, and the on-off control circuit 434 that controls the switch 423 based on the converted analog value.

The lighting state instruction received by the communication circuit 431 includes, for example, a parameter for giving an instruction to turn on or off the switch 423. The D/A conversion circuit 433 generates an analog value according to the value of the above parameter and inputs a result to the on-off control circuit 434. In the case of this example, the resistance value control circuit 440 is configured with the communication circuit 431, the decoder circuit 432, the D/A conversion circuit 433, and the on-off control circuit 434.

As such, a mechanism to control the resistance value of the resistance circuit 420 according to the temperature information can be implemented also with the configuration illustrated in the figure. In the case of such a configuration, the above mechanism can be implemented without consuming the resources (constant current source) of the current source 412.

In the vehicle lamp control device 1 illustrated in FIG. 10B, as in the case of the vehicle lamp control device 1 illustrated in FIG. 9C, the resistance element 422b of the resistance circuit 420 in FIG. 10A is replaced with the diode 424 connected in the forward direction. In this example, the resistance value of the resistance circuit 420 when the switch 423 is on can be made zero. For example, with the resistance element 422b having a resistance value greater than zero being connected in series to the switch 423, it is possible to cause the resistance value of the resistance circuit 420 when the switch 423 is on to be a predetermined value greater than zero.

In FIGS. 10C and 10D, as in the vehicle lamp control devices 1 illustrated in FIGS. 9D and 9E, the resistance circuit 420 is configured using the variable resistance element 522a.

FIG. 10C illustrates the case where an analog potentiometer is used as the variable resistance element 522a, as in FIG. 9D. In this example, the LED board 42 is provided with the communication circuit 431 (CAN transceiver, etc.) that receives the resistance value instruction, the decoder circuit 432 that decodes the resistance value instruction, and the D/A conversion circuit 433 that converts the decoded digital value into an analog value and inputs a result to the analog value input terminal 5221 of the variable resistance element 522a. In the case of this circuit, the resistance value control circuit 440 is configured with the communication circuit 431, the decoder circuit 432, and the D/A conversion circuit 433.

FIG. 10D illustrates the case where a digital potentiometer is used as the variable resistance element 522a, as in FIG. 9E. In this example, the LED board 42 is provided with the communication circuit 431 (CAN transceiver, etc.) that receives the resistance value instruction, and the decoder circuit 432 that decodes the resistance value instruction and inputs the decoded digital value to the digital value input terminal 5222 of the variable resistance element 522a. In the case of this circuit, the resistance value control circuit 440 is configured with the communication circuit 431 and the decoder circuit 432.

As has been described above, the vehicle lamp control device 1 of an embodiment of the present disclosure changes the resistance value of the resistance circuit 420 so as to suppress a change in the value of the voltage (Vk) applied to the first constant current source 4121a caused by a change in the temperature of the LED 405, and thus even when the temperature of the LED 405 changes, the value of the voltage applied to the first constant current source 4121a can be maintained within a predetermined range. Thus, it is possible to prevent an increase in power consumption and heat generation caused by an excessively large value of the voltage (Vk) applied to the first constant current source 4121a, and to prevent the LED 405 from failing to light up due to the value of the voltage (Vk) applied to the first constant current source 4121a falling below the value needed to properly operate the first constant current source 4121a (becoming excessively low).

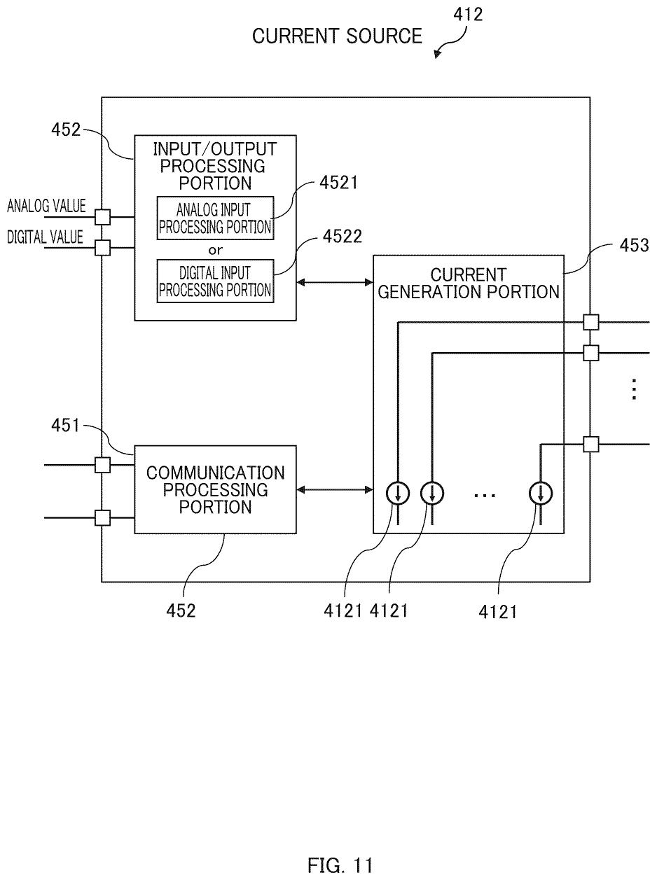

FIG. 11 is a block diagram illustrating a configuration example of the current source 412. The illustrated current source 412 is configured using, for example, a sink driver IC. As illustrated in the figure, the illustrated current source 412 includes the communication processing portion 451, the input/output processing portion 452, and the current generation portion 453.

The communication processing portion 451 functions as, for example, a CAN transceiver. The communication processing portion 451 communicates with the rear ECU 23, such as receiving information (resistance value instruction, etc.) sent from the rear ECU 23. For example, the current generation portion 453 is notified of the information received by the communication processing portion 451 from the rear ECU 23.

The input/output processing portion 452 includes the analog input processing portion 4521 and the digital input processing portion 4522. The analog input processing portion 4521 receives an analog value inputted from the outside (for example, the analog value inputted from the temperature sensor 45, when the temperature sensor 45 of the LED board 42 is of a type of outputting an analog value (analog voltage value) indicating the temperature) and notifies the current generation portion 453 of the received analog value. The digital input processing portion 4522 receives a digital value inputted from the outside, and notifies the current generation portion 453 of the received digital value (for example, the digital value inputted from the temperature sensor 45, when the temperature sensor 45 of the LED board 42 is of a type of outputting a digital value indicating the temperature).

The current generation portion 453 controls the value of the current outputted from the constant current source 4121 based on the information (temperature information, etc.) received from the input/output processing portion 452 and the information (resistance value instruction, etc.) received from the communication processing portion 451.

Although embodiments of the present disclosure have been described in detail above, the present disclosure is not limited to the above embodiments, and various modifications are included. Further, the above embodiments have described the configurations in detail in order to explain the present disclosure in an easy-to-understand manner, and are not necessarily limited to those including all the configurations described. Further, it is possible to add, delete, or replace a part of a configuration of the above embodiment with another configuration.

For example, the above description has focused on one LED array 400, but when a plurality of LED arrays 400 are provided to the LED board 42, the mechanism described above may be applied to each of the LED arrays 400.

As such, the vehicle lamp control device 1 of an embodiment of the present disclosure includes: a first constant current source configured to supply a constant current to a light-emitting element used for a vehicle lamp; a resistance circuit connected in series to the light-emitting element and the first constant current source; a current value control circuit configured to control the current value of the first constant current source; and a resistance value control circuit configured to change the resistance value of the resistance circuit so as to suppress a change in the value of the voltage applied to the first constant current source when the temperature around the light-emitting element changes.

As such, the vehicle lamp control device 1 changes the resistance value of the resistance circuit so as to suppress a change in the value of the voltage applied to the first constant current source when the temperature of the light-emitting element changes. Thus, even when the temperature of the light-emitting element changes, the value of the voltage applied to the first constant current source can be maintained within a predetermined range. Accordingly, it is possible to prevent power consumption and heat generation from increasing and the light-emitting element from failing to light up, which are caused by the value of the voltage applied to the first constant current source becoming excessively large or excessively small.

Further, the vehicle lamp control device 1 of an embodiment of the present disclosure further includes a second constant current source configured to supply a current according to the temperature around the light-emitting element, and the above resistance value control circuit changes the resistance value of the resistance circuit according to the value of the current supplied by the second constant current source.

As such, the vehicle lamp control device 1 changes the resistance value of the resistance circuit by utilizing a constant current source (second constant current source) included in a current source having a plurality of constant current sources, and thus a mechanism to control the resistance value of the resistance circuit according to the temperature around the light-emitting element can be implemented with a simple configuration.

Further, the above resistance circuit of the vehicle lamp control device 1 of an embodiment of the present disclosure includes a first resistance element that is connected in series to the light-emitting element, and a second resistance element and a switch that are connected in series to the light-emitting element and connected in parallel to the first resistance element, and the above resistance value control circuit turns on and off the switch according to the current value of the second constant current source.

According to the above configuration, a mechanism to control the resistance value of the resistance circuit according to the temperature around the light-emitting element can be implemented with a simple configuration.

Further, the above resistance circuit of the vehicle lamp control device 1 of an embodiment of the present disclosure includes a first resistance element that is connected in series to the light-emitting element, and a diode and a switch that are connected in series to the light-emitting element in the forward direction and connected in parallel to the first resistance element, and the above resistance value control circuit turns on and off the switch according to the current value of the second constant current source.

According to the above configuration, a mechanism to control the resistance value of the resistance circuit according to the temperature around the light-emitting element can be implemented with a simple configuration. It is also possible to cause the resistance value of the resistance circuit to be zero by electrically connecting the diode.

Further, the above resistance circuit of the vehicle lamp control device 1 of an embodiment of the present disclosure includes a variable resistance element whose resistance value changes according to a control voltage, and the resistance value control circuit outputs the control voltage according to the current value of the second constant current source.

As such, with the use of the variable resistance element, it is possible to implement, with a simple configuration, a mechanism to control the resistance value of the resistance circuit according to the temperature around the light-emitting element.

Further, the first constant current source and the second constant current source of the vehicle lamp control device 1 of an embodiment of the present disclosure are constant current sources different from each other among a plurality of constant current sources included in one integrated circuit.

Thus, a mechanism to control the resistance value of the resistance circuit according to the ambient temperature of the light-emitting element can be implemented with a simple configuration using one integrated circuit including a plurality of constant current sources, such as a driver IC or the like.

Further, the vehicle lamp control device 1 of an embodiment of the present disclosure further includes a temperature information acquisition circuit configured to acquire temperature information indicating the temperature around the light-emitting element, a notification circuit configured to notify another device communicably connected thereto of the temperature information, and a receiving circuit configured to receive a resistance value instruction for giving an instruction of the resistance value of the resistance circuit, the receiving circuit being configured to be notified of the resistance value instruction generated by the other device, based on the temperature information, and the resistance value control circuit changes the resistance value of the resistance circuit in response to the resistance value instruction received by the receiving circuit.

As such, according to the above configuration, another device such as the rear ECU directly controls the resistance value of the resistance circuit, and thus a mechanism to change the resistance value of the resistance circuit in response to the lighting state instruction can be implemented without consuming the resources (constant current source) of the current source (driver IC).

Further, the above resistance circuit of the vehicle lamp control device 1 of an embodiment of the present disclosure includes a first resistance element that is connected in series to the light-emitting element, and a second resistance element and a switch that are connected in series to the light-emitting element and connected in parallel to the first resistance element, and the resistance value control circuit turns on and off the switch in response to the resistance value instruction.

According to the above configuration, a mechanism to control the resistance value of the resistance circuit in response to the resistance value instruction can be implemented with a simple configuration.

### Third Embodiment

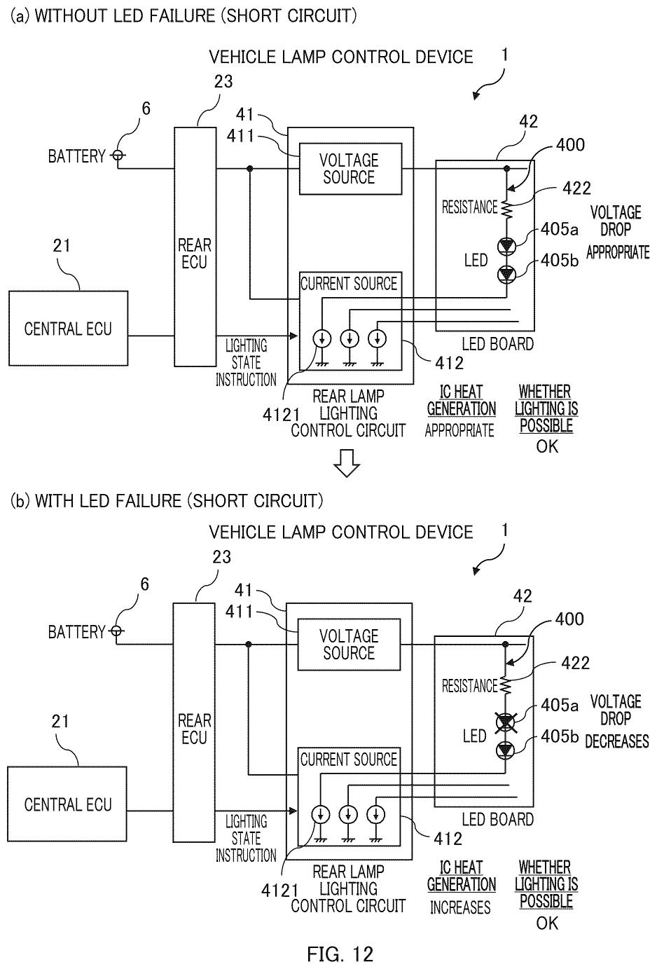

In the configuration illustrated in FIG. 3, for example, when one of the LEDs 405 constituting the LED array 400 is short-circuited, the voltage drop in the LED array 400 decreases, and the value of the voltage (hereinafter referred to as “Vk”) applied to the constant current source 4121 supplying a current to the LED array 400 increases, which may result in an increase in power consumption and heat generation of the constant current source 4121. Hereinafter, this situation will be specifically described with reference to FIG. 12.

For example, such a case is considered where the LED array 400 includes two LEDs 405a and 405b connected in series, and the value of the resistance element 422 is designed such that the voltage value (Vk) of the constant current source 4121 becomes appropriate when these are normally lit.

In this case, as illustrated in FIG. 12(a), when both the LED 405a and the LED 405b are operating normally, the voltage drop in the LED 405a and LED 405b is appropriate, and the value of the voltage (Vk) applied to the constant current source 4121 is also appropriate.

On the other hand, as illustrated in FIG. 12(b), when one of the LEDs 405 (for example, “LED 405a”) is short-circuited, the voltage drop in the LED 405a and LED 405b decreases, the value of the voltage (Vk) applied to the constant current source 4121 changes, which leads to an increase in power consumption and heat generation of the constant current source 4121.

As such, in the configuration of the vehicle lamp control device 1 illustrated in FIG. 3, the resistance value of the resistance element 422 being fixed may lead to an increase in power consumption and heat generation of the constant current source 4121 if the LED 405 is short-circuited.

Thus, in an embodiment of the present disclosure, the above issue is solved by providing a resistance circuit capable of changing the resistance value in the LED array 200. The following describes a specific configuration of the vehicle lamp control device 1 of an embodiment of the present disclosure.

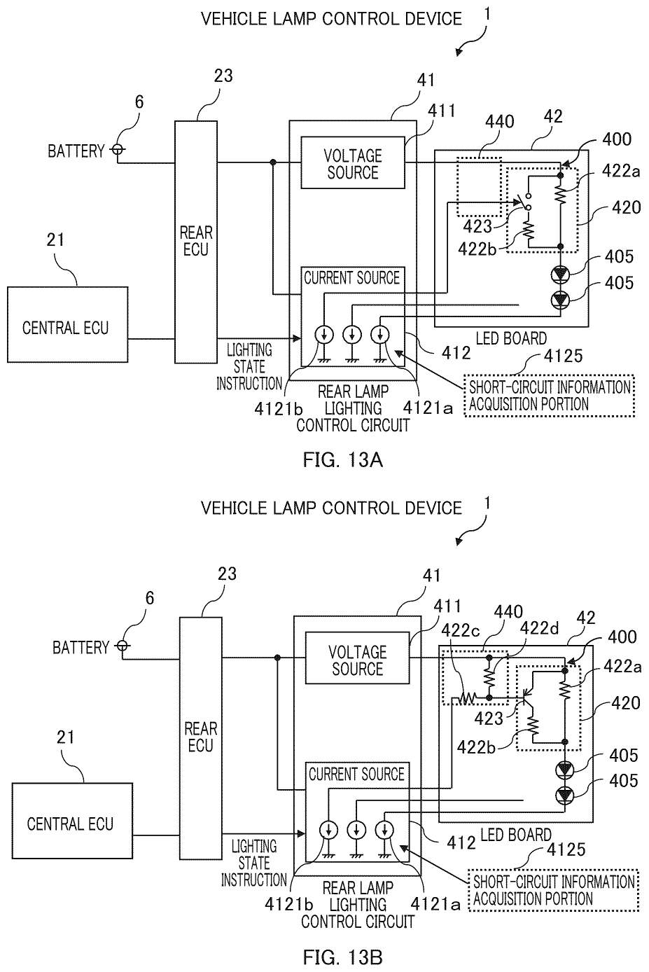

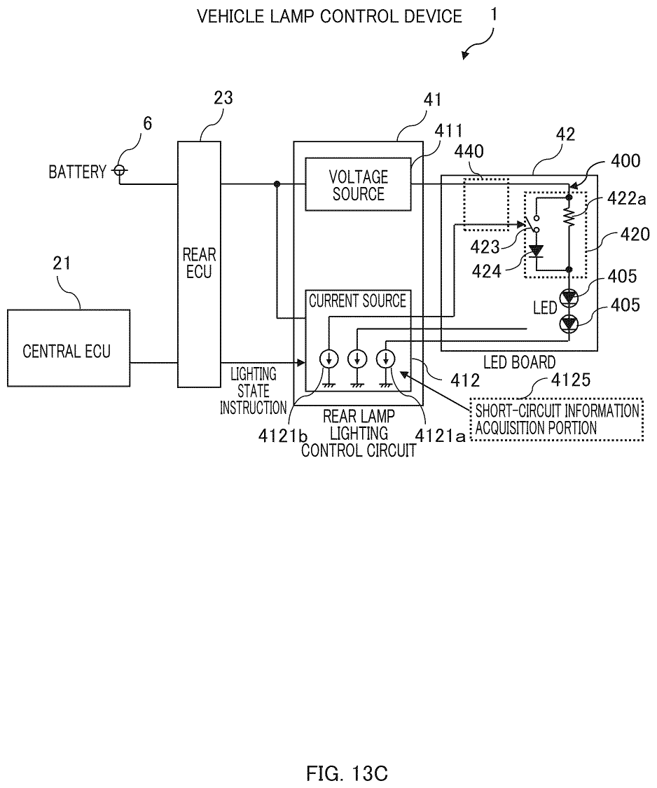

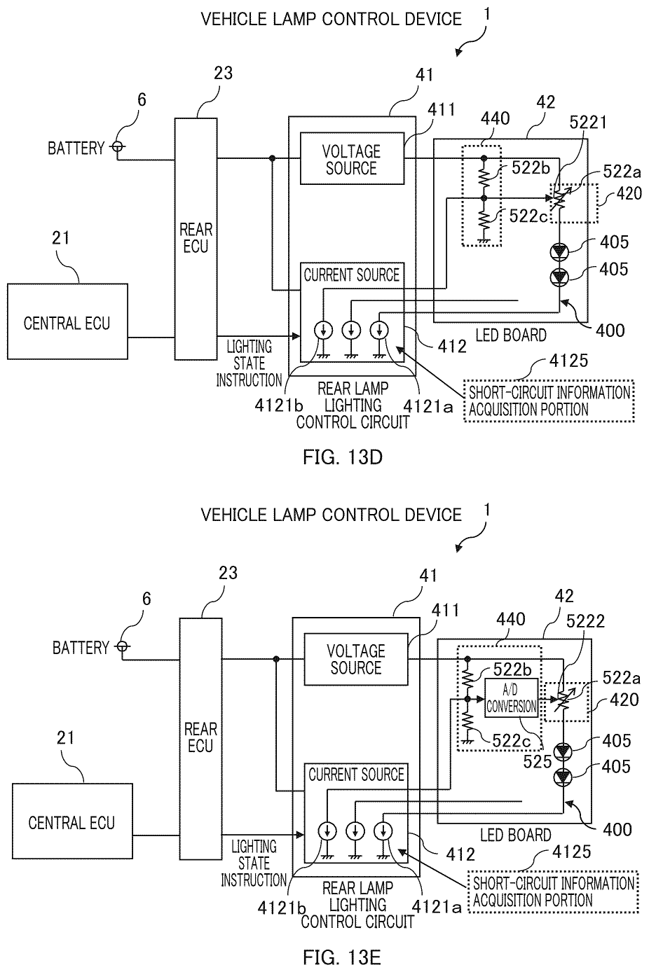

FIG. 13A is a configuration example of the vehicle lamp control device 1 of an embodiment of the present disclosure. In the illustrated vehicle lamp control device 1, a resistance circuit 420 is provided in series with the LED 405 constituting the LED array 400, and a circuit that controls the resistance value of the resistance circuit 420 (hereinafter referred to as “resistance value control circuit 440”) is provided. The resistance circuit 420 includes the resistance element 422a, the resistance element 422b connected in parallel to the resistance element 422a, and the switch 423 connected in series to the resistance element 422b, to turn on and off the connection to the LED 405. The specific configuration of the resistance value control circuit 440 will be described later.

In the example of the figure, the on and off of the switch 423 is controlled by changing the current value of another constant current source 4121 (hereinafter also referred to as “second constant current source 4121b”) different from the constant current source 4121 (hereinafter also referred to as “first constant current source 4121a”) supplying a current to the LED array 400 among the plurality of constant current sources 4121 included in the current source 412.

The current source 412 has a short-circuit information acquisition portion 4125 configured to acquire information indicating whether a short circuit has occurred in the LED 405 constituting the LED array 400 (hereinafter referred to as “short-circuit information”). The short-circuit information acquisition portion 4125 may be, for example, a short-circuit detection circuit included in the driver IC constituting the current source 412, or may be a circuit separately provided in the rear lamp lighting control circuit 41.

Note that the short-circuit information acquisition portion 4125 determines whether a short circuit has occurred in the LED 405 of the LED array 400 by, for example, monitoring the voltage value (Vk) of the first constant current source 4121a of the current source 412. For example, the short-circuit information acquisition portion 4125 detects whether a short circuit has occurred in the LED 405 of the LED array 400 connected to the first constant current source 4121a based on whether the voltage value (Vk) of the first constant current source 4121a is higher than a predetermined voltage. Here, the above predetermined voltage is set based on, for example, the value of the voltage applied to the LED array 400 by the voltage source 411, the resistance value of the resistance circuit 420, the voltage drop of the LED 405, and the constant current value of the first constant current source 4121a.

The current source 412 controls the current value of the second constant current source 4121b according to the short-circuit information acquired by the short-circuit information acquisition portion 4125, and switches the on and off of the switch 423.

For example, when detecting that none of the LEDs 405 constituting the LED array 400 are short-circuited based on the short-circuit information, the current source 412 maintains the current value of the second constant current source 4121b at a predetermined value, to turn on the switch 423, thereby reducing the resistance value of the resistance circuit 420 (reducing the voltage drop in the resistance circuit 420) and maintaining the value of the voltage (Vk) applied to the first constant current source 4121a at an appropriate value.

Further, for example, when detecting that one of the LEDs 405 constituting the LED array 400 is short-circuited based on the short-circuit information, the current source 412 controls the current value of the second constant current source 4121b, to turn off the switch 423, thereby increasing the resistance value of the resistance circuit 420 (increasing the voltage drop in the resistance circuit 420) and preventing a rise in the value of the voltage (Vk) applied to the first constant current source 4121a.

Incidentally, when there are three or more LEDs 405 constituting the same LED array 400, it is also assumed that two or more of the LEDs 405 are short-circuited at the same time. In that case, the short-circuit information acquisition portion 4125 may acquire information indicating the presence or absence of a short circuit of at least any of the plurality of LEDs 405 as short-circuit information, and control the resistance value of the resistance circuit 420 according to the magnitude of the voltage drop grasped from the acquired short-circuit information. By doing so, even when two or more LEDs 405 constituting the same LED array 400 are short-circuited at the same time, it is possible to appropriately suppress the change in the value of the voltage (Vk) applied to the first constant current source 4121a. When it is detected that all the LEDs 405 constituting the LED array 400 are short-circuited, the current source 412, for example, stops supplying a current from the first constant current source 4121a to the LED array 400, or treats this LED array 400 as a micro-resistance load and controls the resistance value of the resistance circuit 420, to thereby suppress the change in the value of the voltage (Vk) applied to the first constant current source 4121a, as in the case where some of the LEDs 405 are short-circuited.

As such, the illustrated vehicle lamp control device 1 controls the resistance value of the resistance circuit 420 by controlling the value of the current supplied from the second constant current source according to the short-circuit information, thereby suppressing the change in the value of the voltage (Vk) applied to the first constant current source 4121a. Thus, even when the LED 405 constituting the LED array 400 is short-circuited, the value of the voltage (Vk) applied to the first constant current source 4121a can be maintained at an appropriate value.

Further, in the illustrated vehicle lamp control device 1, the current source 412 changes the current value of the second constant current source 4121b, which is different from the first constant current source 4121a, among the plurality of constant current sources 4121 included in the current source 412, in other words, changes the resistance value of the resistance circuit 420 by utilizing the second constant current source 4121b, which is one of the constant current sources 4121 of the current source 412. Thus, a mechanism to control the resistance value of the resistance circuit 420 according to the short-circuit information can be implemented with a simple configuration.

FIG. 13B is the case where the switch 423 illustrated in FIG. 13A is configured using a transistor. In this example, the emitter of the transistor is connected to the voltage source 411, and the collector thereof is connected to the resistance element 422b. The base of the transistor is connected to the second constant current source 4121b via the resistance element 422c and to the voltage source 411 via the resistance element 422d. The base of the transistor is applied with a voltage determined by the voltage value of the voltage source 411, the value of the current supplied from the second constant current source 4121b, the resistance value of the resistance element 422c, and the resistance value of the resistance element 422d. That is, in the example of the figure, the resistance value control circuit 440 is configured with the resistance element 422c and the resistance element 422d.

Note that in the example of FIG. 13B, the switch 423 is configured using a PNP transistor. Thus, when the value of the current supplied from the second constant current source 4121b is small and the voltage drop in the resistance element 422d is equal to or less than a predetermined value, the switch 423 is off, and when the current value is large and the voltage drop in the resistance element 422d exceeds a predetermined value, the switch 423 is on.

Note that the switch 423 may be configured using another type of element such as, for example, a field-effect transistor (FET). When the switch 423 is configured using a field-effect transistor, the drain thereof is connected to the voltage source 411 and the source thereof is connected to the resistance element 422b. The gate thereof is connected to the second constant current source 4121b via the resistance element 422c and to the voltage source 411 via the resistance element 422d.

As such, the on and off of the switch 423 can be controlled by changing the value of the current supplied from the second constant current source 4121b. A mechanism to control the resistance value of the resistance circuit according to the short-circuit information can be simply configured using a resistance element and the switch 423.

FIG. 13C is another configuration example of the vehicle lamp control device 1. In this example, the resistance element 422b connected in series to the switch 423 of the resistance circuit 420 in FIG. 13B is replaced with the diode 424 connected in the forward direction to the LED array 400. The resistance value of the resistance circuit 420 when the switch 423 is off is the resistance value of the resistance element 422a. When the switch 423 is on, the resistance value of the resistance circuit 420 reaches zero. In order to cause the resistance value of the resistance circuit 420 to be a predetermined value other than zero even when the switch 423 is on, for example, a resistance element only have to be connected in series to the switch 423. Although a specific configuration is omitted in the figure, as the resistance value control circuit 440 in this resistance circuit 420, for example, the circuit illustrated in FIG. 13B (circuit configured with the resistance element 422c and the resistance element 422d) can be used.

FIG. 13D is another configuration example of the vehicle lamp control device 1. In this example, the resistance value of the resistance circuit 420 connected to the LED array 400 is changed by the variable resistance element 522a connected in series to the LED array 400. This example uses, as the variable resistance element 522a, a potentiometer of a type in which the resistance value is set with an analog value (voltage value) (hereinafter referred to as “analog potentiometer”).

As illustrated in the figure, the analog value input terminal 5221 of the variable resistance element 522a is connected to the second constant current source 4121b. A voltage obtained by dividing the voltage of the voltage source 411 by the resistance value of the resistance element 522b and the resistance value of the resistance element 522c is applied to the input terminal 5221. The resistance value of the resistance element 522b and the resistance value of the resistance element 522c are each set according to, for example, the range of the resistance value needed for the resistance circuit 420. In this example, the resistance value control circuit 440 is configured with the resistance element 522b and the resistance element 522c.

The vehicle lamp control device 1 illustrated in FIG. 13E is, as in FIG. 13D, the case where the resistance value of the resistance circuit 420 connected to the LED array 400 is changed by the variable resistance element 522a connected in series to the LED array 400. This example uses, as the variable resistance element 522a, a potentiometer of a type in which the resistance value is set by inputting a digital value specifying the resistance value (hereinafter referred to as “digital potentiometer”).

In this example, the analog voltage value obtained by voltage division by the resistance element 522b and the resistance element 522c is converted into a digital value by the A/D conversion circuit 525, and the converted digital value is inputted to the digital value input terminal 5222 of the variable resistance element 522a. In the case of this circuit, the resistance value control circuit 440 is configured with the resistance element 522b, the resistance element 522c, and the A/D conversion circuit 525.

As such, a mechanism to change the resistance value of the resistance circuit 420 according to the short-circuit information can be simply configured using a variable resistance element such as an analog potentiometer or a digital potentiometer. When a digital potentiometer is used as the variable resistance element 522a, the advantages of the digital potentiometer (high precision, high resolution, small size, high stability, long life, high reliability, etc.) can be enjoyed.

Further, in the configurations illustrated in FIGS. 13A to 13C described above, since the resistance values of the resistance element 422a and the resistance element 422b are fixed, the resistance value of the resistance circuit 420 can only be changed in a stepwise manner (discontinuously). On the other hand, in the configuration illustrated in FIG. 13D or FIG. 13E, the variable resistance element 522a is used, and thus the resistance value of the resistance circuit 420 can be changed continuously. Thus, the value of the resistance circuit 420 can be finely controlled according to the short-circuit information. For example, when a plurality of LEDs 405 in the same LED array 400 are short-circuited at the same time, the value of the resistance circuit 420 can be controlled according to the number of short-circuited LEDs 405.

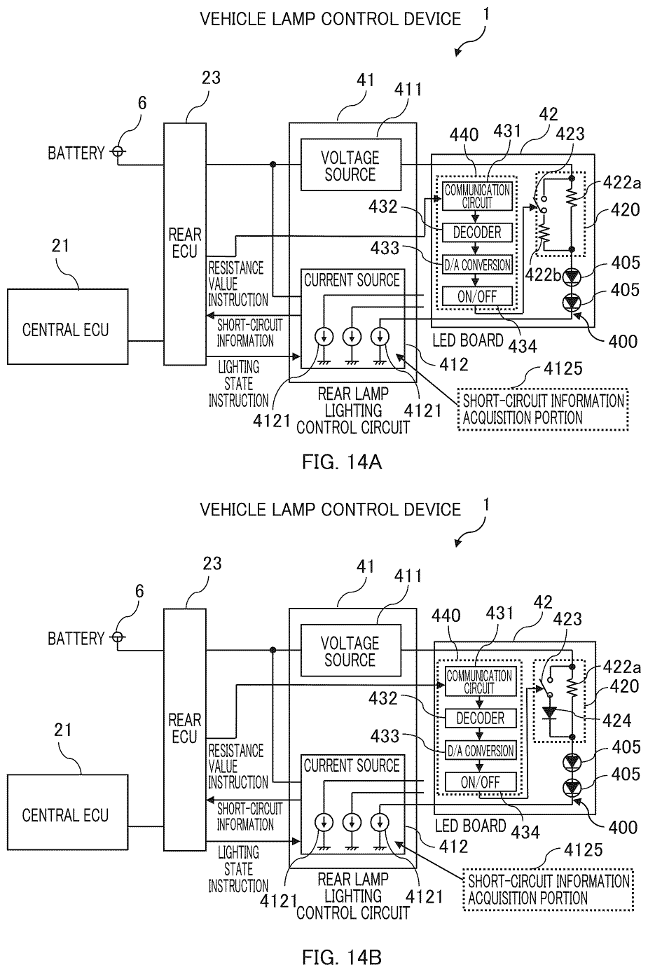

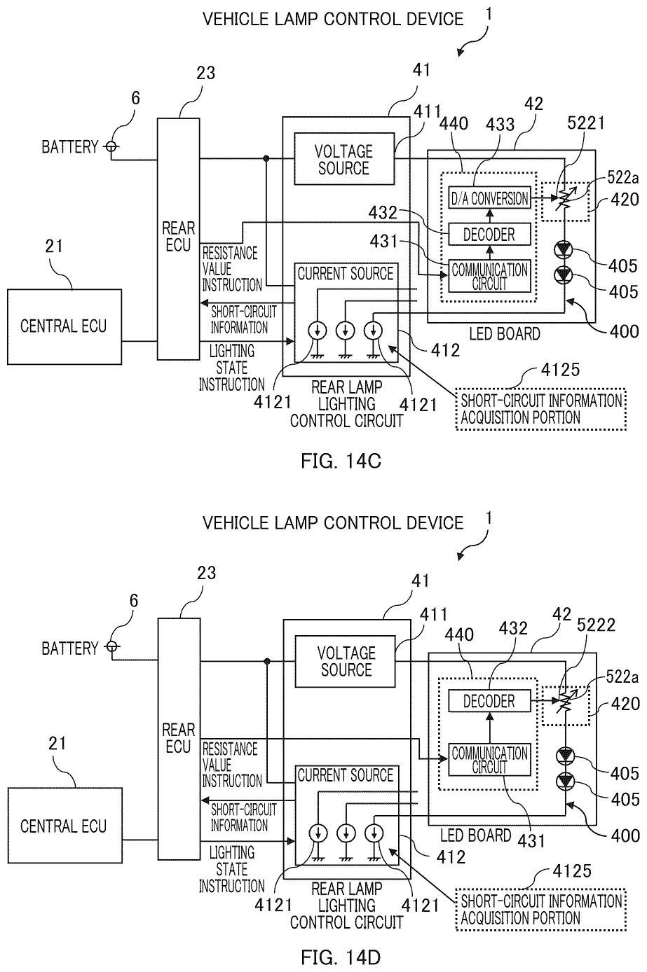

FIGS. 14A to 14D are other configuration examples of the vehicle lamp control device 1. In the vehicle lamp control devices 1 illustrated in FIGS. 13A to 13E, the resistance value of the resistance circuit 420 is changed utilizing the constant current source 4121 (second constant current source 4121b) of the current source 412. On the other hand, in the vehicle lamp control devices 1 illustrated in FIGS. 14A to 14D, the short-circuit information acquisition portion 4125 of the rear lamp lighting control circuit 41 notifies the rear ECU 23 of the acquired short-circuit information, and the rear ECU 23 transmits an instruction to change the resistance value of the resistance circuit 420 (hereinafter referred to as “resistance value instruction”) to the LED board 42 based on the received short-circuit information. The LED board 42 changes the resistance value of the resistance circuit 420 based on the resistance value instruction received from the rear ECU 23.

Note that the resistance circuit 420 in the vehicle lamp control device 1 illustrated in FIG. 14A is, for example, the same as that illustrated in FIG. 13A or FIG. 13B. As illustrated in the figure, a notification of the short-circuit information acquired by the short-circuit information acquisition portion 4125 of the rear lamp lighting control circuit 41 is provided to the rear ECU 23 via, for example, a circuit such as wiring or a communication line. In this example, the LED board 42 is provided with the communication circuit 431 (CAN transceiver, etc.) that receives the short-circuit information, the decoder circuit 432 that decodes the received short-circuit information, the D/A conversion circuit 433 that converts the decoded digital value into an analog value, and the on-off control circuit 434 that controls the switch 423 based on the converted analog value.

The resistance value instruction received by the communication circuit 431 includes, for example, a parameter for giving an instruction to turn on or off the switch 423. The D/A conversion circuit 433 generates an analog value according to the value of the above parameter and inputs it to the on-off control circuit 434. In the case of this example, the resistance value control circuit 440 is configured with the communication circuit 431, the decoder circuit 432, the D/A conversion circuit 433, and the on-off control circuit 434.

As such, a mechanism to control the resistance value of the resistance circuit 420 according to the short-circuit information can also be implemented with the configuration illustrated in the figure. In the case of such a configuration, the above mechanism can be implemented without consuming the resources (constant current source) of the current source 412.

In the vehicle lamp control device 1 illustrated in FIG. 14B, as in the case of the vehicle lamp control device 1 illustrated in FIG. 13C, the resistance element 422b of the resistance circuit 420 in FIG. 14A is replaced with the diode 424 connected in the forward direction. In this example, the resistance value of the resistance circuit 420 when the switch 423 is on can be made zero. Further, for example, by connecting the resistance element 422b having a resistance value greater than zero in series to the switch 423, the resistance value of the resistance circuit 420 when the switch 423 is on can be set to a predetermined value greater than zero.

In FIGS. 14C and 14D, as in the vehicle lamp control devices 1 illustrated in FIGS. 13D and 13E, the resistance circuit 420 is configured using the variable resistance element 522a.

FIG. 14C illustrates the case where an analog potentiometer is used as the variable resistance element 522a, as in FIG. 13D. In this example, the LED board 42 is provided with the communication circuit 431 (CAN transceiver, etc.) that receives the resistance value instruction, the decoder circuit 432 that decodes the resistance value instruction, and the D/A conversion circuit 433 that converts the decoded digital value into an analog value and inputs a result to the analog value input terminal 5221 of the variable resistance element 522a. In the case of this circuit, the resistance value control circuit 440 is configured with the communication circuit 431, the decoder circuit 432, and the D/A conversion circuit 433.

FIG. 14D illustrates the case where a digital potentiometer is used as the variable resistance element 522a, as in FIG. 13E. In this example, the LED board 42 is provided with the communication circuit 431 (CAN transceiver, etc.) that receives the resistance value instruction, and the decoder circuit 432 that decodes the resistance value instruction and inputs the decoded digital value to the digital value input terminal 5222 of the variable resistance element 522a. In the case of this circuit, the resistance value control circuit 440 is configured with the communication circuit 431 and the decoder circuit 432.

As has been described above, the vehicle lamp control device 1 of an embodiment of the present disclosure changes the resistance value of the resistance circuit 420 so as to suppress a change in the value of the voltage (Vk) applied to the first constant current source 4121a when the LED 405 is short-circuited, and thus even when the LED 405 is short-circuited, the value of the voltage applied to the first constant current source 4121a can be maintained within a predetermined range. Thus, it is possible to prevent an increase in power consumption and heat generation caused by the value of the voltage (Vk) applied to the first constant current source 4121a becoming excessively large.

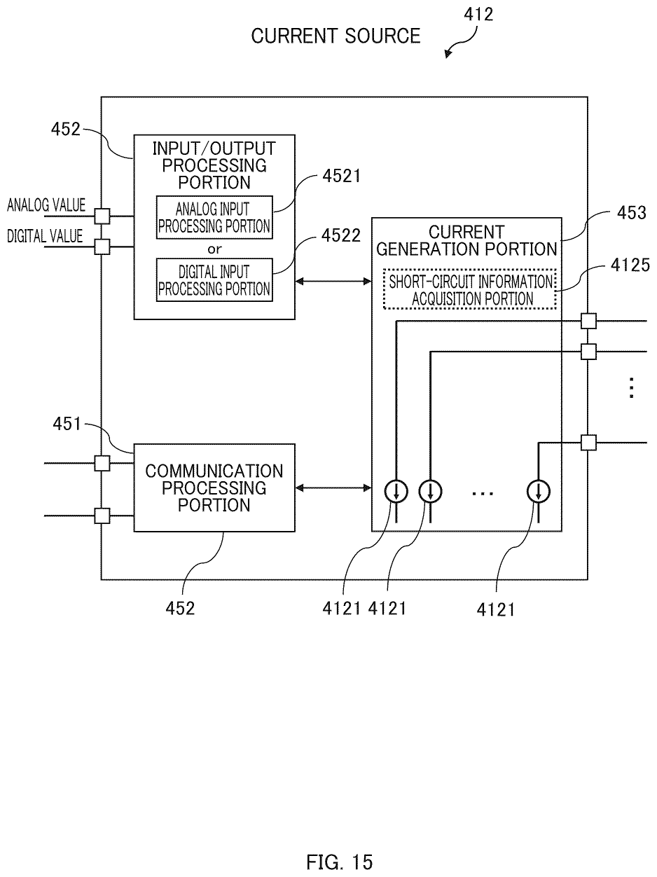

FIG. 15 is a block diagram illustrating a configuration example of the current source 412. The illustrated current source 412 is configured using, for example, a sink driver IC. As illustrated in the figure, the illustrated current source 412 includes the communication processing portion 451, the input/output processing portion 452, and the current generation portion 453.

The communication processing portion 451 functions as, for example, a CAN transceiver. The communication processing portion 451 communicates with the rear ECU 23, such as transmitting short-circuit information to the rear ECU 23, receiving information (resistance value instruction, etc.) sent from the rear ECU 23, and the like. For example, the current generation portion 453 is notified of the information received by the communication processing portion 451 from the rear

### ECU 23.

The input/output processing portion 452 includes the analog input processing portion 4521 and the digital input processing portion 4522. The analog input processing portion 4521 receives an analog value inputted from the outside and notifies the current generation portion 453 of the received analog value. The digital input processing portion 4522 receives a digital value inputted from the outside and notifies the current generation portion 453 of the received digital value.

The current generation portion 453 controls the value of the current outputted from the constant current source 4121, based on the information (resistance value instruction, etc.) received from the communication processing portion 451. The current generation portion 453 includes the short-circuit information acquisition portion 4125 configured to acquire the above-described short-circuit information.

Although embodiments of the present disclosure have been described in detail above, the present disclosure is not limited to the above embodiments, and various modifications are included. Further, the above embodiments have described the configurations in detail in order to explain the present disclosure in an easy-to-understand manner, and are not necessarily limited to those having all the configurations described. Further, it is possible to add, delete, or replace a part of a configuration of the above embodiments with another configuration.

For example, the above description has focused on one LED array 400, but when a plurality of LED arrays 400 are provided to the LED board 42, the mechanism described above may be applied to each of the LED arrays 400.

As has been described above, the vehicle lamp control device 1 of an embodiment of the present disclosure includes: a first constant current source configured to supply a constant current to a light-emitting element used in a vehicle lamp; a resistance circuit connected in series to the light-emitting element and the first constant current source; a current value control circuit configured to control the current value of the first constant current source; and a resistance value control circuit configured to change the resistance value of the resistance circuit so as to suppress a change in the value of the voltage applied to the first constant current source when the light-emitting element is short-circuited.

As such, the vehicle lamp control device 1 changes the resistance value of the resistance circuit so as to suppress the change in the value of the voltage applied to the first constant current source when the light-emitting element is short-circuited. Thus, even when the light-emitting element is short-circuited, the value of the voltage applied to the first constant current source can be maintained within a predetermined range. Accordingly, it is possible to prevent an increase in power consumption and heat generation caused by the value of the voltage applied to the first constant current source becoming excessively large due to the light-emitting element being short circuited.

Further, the vehicle lamp control device 1 of an embodiment of the present disclosure further includes a second constant current source configured to supply a current according to the presence or absence of the short circuit of the light-emitting element, and the above resistance value control circuit changes the resistance value of the resistance circuit according to the value of the current supplied by the second constant current source.

As such, the vehicle lamp control device 1 changes the resistance value of the resistance circuit by utilizing one (second constant current source) of the constant current sources included in a current source (such as a driver IC) having a plurality of constant current sources, thereby being able to implement, with a simple configuration, a mechanism to control the resistance value of the resistance circuit in accordance with the short circuit of the light-emitting element.

Further, the above resistance circuit of the vehicle lamp control device 1 of an embodiment of the present disclosure includes a first resistance element connected in series to the light-emitting element, and a second resistance element and a switch connected in series to the light-emitting element, and connected in parallel to the first resistance element, and the above resistance value control circuit turns on and off the switch according to the current value of the second constant current source.

According to the above configuration, it is possible to implement, with a simple configuration, a mechanism to control the resistance value of the resistance circuit in accordance with the short circuit of the light-emitting element.

Further, the above resistance circuit of the vehicle lamp control device 1 according to an embodiment of the present disclosure includes a first resistance element that is connected in series to the light-emitting element, and a diode and a switch that are connected in series to the light-emitting element in the forward direction, and connected in parallel to the first resistance element, and the resistance value control circuit turns on and off the switch according to the current value of the second constant current source.

According to the above configuration, it is possible to implement, with a simple configuration, a mechanism to control the resistance value of the resistance circuit in accordance with the short circuit of the light-emitting element. It is also possible to cause the resistance value of the resistance circuit to be zero by electrically connecting the diode.

Further, the above resistance circuit of the vehicle lamp control device 1 according to an embodiment of the present disclosure includes a variable resistance element whose resistance value changes according to a control voltage, and the above resistance value control circuit outputs the control voltage according to the current value of the second constant current source.

As such, with the use of the variable resistance element, it is possible to implement, with a simple configuration, a mechanism to control the resistance value of the resistance circuit in accordance with the short circuit of the light-emitting element.

Further, the first constant current source and the second constant current source of the vehicle lamp control device 1 of an embodiment of the present disclosure are constant current sources different from each other among a plurality of constant current sources included in one integrated circuit.

Thus, a mechanism to control the resistance value of the resistance circuit according to the short circuit of the light-emitting element can be implemented with a simple configuration, using one single integrated circuit including a plurality of constant current sources, such as a driver IC.

Further, the vehicle lamp control device 1 of an embodiment of the present disclosure further includes a short-circuit information acquisition portion configured to acquire short-circuit information indicating the presence or absence of the short circuit of the light-emitting element, a notification circuit configured to notify another device communicably connected thereto of the short-circuit information, and a receiving circuit configured to receive a resistance value instruction for giving an instruction of the resistance value of the above resistance circuit, the receiving circuit being configured to be notified of the resistance value instruction generated by the other device based on the short-circuit information, and the above resistance value control circuit changes the resistance value of the resistance circuit in response to the resistance value instruction received by the receiving circuit.

As such, according to the above configuration, another device such as the rear ECU or the like directly controls the resistance value of the resistance circuit, thereby being able to implement a mechanism to change the resistance value of the resistance circuit according to the short circuit of the light-emitting element, without consuming the resources (constant current source) of the current source (driver IC).

### SUPPLEMENTAL DISCLOSURE

### [Item 1]

A vehicle lamp control device comprising:
a first constant current source configured to supply a constant current to a light-emitting element used in a vehicle lamp;
a resistance circuit connected in series to the light-emitting element and the first constant current source;
a current value control circuit configured to control a value of a current of the first constant current source in response to a lighting state instruction for giving an instruction of a lighting state of the light-emitting element; and
a resistance value control circuit configured to change a resistance value of the resistance circuit so as to suppress a change in a value of a voltage applied to the first constant current source when a value of a current supplied to the light-emitting element changes.

### [Item 2]

The vehicle lamp control device according to Item 1, further comprising:
a second constant current source configured to supply a current in response to the lighting state instruction, wherein
the resistance value control circuit changes the resistance value of the resistance circuit according to the value of the current supplied by the second constant current source.

### [Item 3]

The vehicle lamp control device according to Item 2, wherein
the resistance circuit includes
   a first resistance element that is connected in series to the light-emitting element, and
   a second resistance element and a switch that are connected in series to the light-emitting element, and connected in parallel to the first resistance element, and
the resistance value control circuit turns on and off the switch according to the value of the current of the second constant current source.

### [Item 4]

The vehicle lamp control device according to Item 2, wherein
the resistance circuit includes
   a first resistance element that is connected in series to the light-emitting element, and
   a diode and a switch that are connected in series to the light-emitting element in a forward direction, and connected in parallel to the first resistance element, and
the resistance value control circuit turns on and off the switch according to the value of the current of the second constant current source.

### [Item 5]

The vehicle lamp control device according to Item 2, wherein
the resistance circuit includes a variable resistance element whose resistance value changes according to a control voltage, and
the resistance value control circuit outputs the control voltage according to the value of the current of the second constant current source.

### [Item 6]

The vehicle lamp control device according to Item 2, wherein
the first constant current source and the second constant current source are constant current sources different from each other among a plurality of constant current sources included in one integrated circuit.

### [Item 7]

The vehicle lamp control device according to Item 1, further comprising:
a receiving circuit configured to receive the lighting state instruction from another device communicably connected thereto, wherein
the resistance value control circuit changes the resistance value of the resistance circuit in response to the lighting state instruction received by the receiving circuit.

### [Item 8]

The vehicle lamp control device according to Item 7, wherein
the resistance circuit includes
   a first resistance element that is connected in series to the light-emitting element, and
   a second resistance element and a switch that are connected in series to the light-emitting element, and connected in parallel to the first resistance element, and
the resistance value control circuit turns on and off the switch in response to the lighting state instruction.

### [Item 9]

The vehicle lamp control device according to Item 7, wherein
the resistance circuit includes
   a first resistance element that is connected in series to the light-emitting element, and
   a diode and a switch that are connected in series to the light-emitting element in a forward direction, and connected in parallel to the first resistance element, and
the resistance value control circuit turns on and off the switch in response to the lighting state instruction.

### [Item 10]

The vehicle lamp control device according to Item 7, wherein
the resistance circuit includes a variable resistance element whose resistance value changes according to a control voltage, and
the resistance value control circuit outputs the control voltage.

### [Item 11]

The vehicle lamp control device according to Item 1, further comprising:
a second information processing device communicably connected to a first information processing device, wherein
the second information processing device
   stores software to implement a process of generating the lighting state instruction,
   receives update information of the software from the first information processing device, and
   updates the software to content for causing the value of the current supplied to the light-emitting element to change before and after an update, based on the received update information.

### [Item 12]

The vehicle lamp control device according to Item 1, wherein
the vehicle lamp is a rear lamp, and
the light-emitting element constitutes a light source of the rear lamp.

### [Item 13]

A vehicle lamp control device comprising:
a first constant current source configured to supply a constant current to a light-emitting element used in a vehicle lamp;
a resistance circuit connected in series to the light-emitting element and the first constant current source;
a current value control circuit configured to control a value of a current of the first constant current source; and
a resistance value control circuit configured to change a resistance value of the resistance circuit so as to suppress a change in a value of a voltage applied to the first constant current source when a temperature around the light-emitting element changes.

[Item 14]

The vehicle lamp control device according to Item 13, further comprising:
a second constant current source configured to supply a current according to the temperature around the light-emitting element, wherein
the resistance value control circuit changes the resistance value of the resistance circuit according to a value of the current supplied by the second constant current source.

### [Item 15]

The vehicle lamp control device according to Item 14, wherein
the resistance circuit includes
   a first resistance element that is connected in series to the light-emitting element, and
   a second resistance element and a switch that are connected in series to the light-emitting element, and connected in parallel to the first resistance element, and
the resistance value control circuit turns on and off the switch according to the value of the current of the second constant current source.

### [Item 16]

The vehicle lamp control device according to Item 14, wherein
the resistance circuit includes
   a first resistance element that is connected in series to the light-emitting element, and
   a diode and a switch that are connected in series to the light-emitting element in a forward direction, and connected in parallel to the first resistance element, and
the resistance value control circuit turns on and off the switch according to the value of the current of the second constant current source.

### [Item 17]

The vehicle lamp control device according to Item 14, wherein
the resistance circuit includes a variable resistance element whose resistance value changes according to a control voltage, and
the resistance value control circuit outputs the control voltage according to the value of the current of the second constant current source.

### [Item 18]

The vehicle lamp control device according to Item 14, wherein
the first constant current source and the second constant current source are constant current sources different from each other among a plurality of constant current sources included in one integrated circuit.

### [Item 19]

The vehicle lamp control device according to Item 13, further comprising:
a temperature information acquisition circuit configured to acquire temperature information indicating a temperature around the light-emitting element;
a notification circuit configured to notify another device communicably connected thereto of the temperature information; and
a receiving circuit configured to receive a resistance value instruction for giving an instruction of the resistance value of the resistance circuit, the receiving circuit being configured to be notified of the resistance value instruction generated by the other device, based on the temperature information, wherein
the resistance value control circuit changes the resistance value of the resistance circuit in response to the resistance value instruction received by the receiving circuit.

### [Item 20]

The vehicle lamp control device according to Item 19, wherein
the resistance circuit includes
   a first resistance element that is connected in series to the light-emitting element, and
   a second resistance element and a switch that are connected in series to the light-emitting element, and connected in parallel to the first resistance element, and
the resistance value control circuit turns on and off the switch in response to the resistance value instruction.

### [Item 21]

The vehicle lamp control device according to Item 19, wherein
the resistance circuit includes
   a first resistance element that is connected in series to the light-emitting element, and
   a diode and a switch that are connected in series to the light-emitting element in a forward direction, and connected in parallel to the first resistance element, and
the resistance value control circuit turns on and off the switch in response to the resistance value instruction.

### [Item 22]

The vehicle lamp control device according to Item 19, wherein
the resistance circuit includes a variable resistance element whose resistance value changes according to a control voltage, and
the resistance value control circuit outputs the control voltage.

### [Item 23]

The vehicle lamp control device according to Item 13, wherein
the vehicle lamp is a rear lamp, and the light-emitting element constitutes a light source of the rear lamp.

### [Item 24]

A vehicle lamp control device comprising:
a first constant current source configured to supply a constant current to a light-emitting element used in a vehicle lamp;
a resistance circuit connected in series to the light-emitting element and the first constant current source;

a current value control circuit configured to control a value of a current of the first constant current source; and
a resistance value control circuit configured to change a resistance value of the resistance circuit so as to suppress a change in a value of a voltage applied to the first constant current source when the light-emitting element is short-circuited.

### [Item 25]

The vehicle lamp control device according to Item 24, further comprising:
a second constant current source configured to supply a current according to presence or absence of a short circuit of the light-emitting element, wherein
the resistance value control circuit changes the resistance value of the resistance circuit according to the value of the current supplied by the second constant current source.

### [Item 26]

The vehicle lamp control device according to Item 25, wherein
the resistance circuit includes
   a first resistance element that is connected in series to the light-emitting element, and
   a second resistance element and a switch that are connected in series to the light-emitting element, and connected in parallel to the first resistance element, and
the resistance value control circuit turns on and off the switch according to the value of the current of the second constant current source.

### [Item 27]

The vehicle lamp control device according to Item 25, wherein
the resistance circuit includes
   a first resistance element that is connected in series to the light-emitting element, and
   a diode and a switch that are connected in series to the light-emitting element in a forward direction, and connected in parallel to the first resistance element, and
the resistance value control circuit turns on and off the switch according to the value of the current of the second constant current source.

### [Item 28]

The vehicle lamp control device according to Item 25, wherein
the resistance circuit includes a variable resistance element whose resistance value changes according to a control voltage, and
the resistance value control circuit outputs the control voltage according to the value of the current of the second constant current source.

### [Item 29]

The vehicle lamp control device according to Item 25, wherein
the first constant current source and the second constant current source are constant current sources different from each other among a plurality of constant current sources included in one integrated circuit.

### [Item 30]

The vehicle lamp control device according to Item 24, further comprising:
a short-circuit information acquisition portion configured to acquire short-circuit information indicating presence or absence of a short circuit of the light-emitting element;
a notification circuit configured to notify another device communicably connected thereto of the short-circuit information; and
a receiving circuit configured to receive a resistance value instruction for giving an instruction of the resistance value of the resistance circuit, the receiving circuit being configured to be notified of the resistance value instruction generated by the other device, based on the short-circuit information, wherein
the resistance value control circuit changes the resistance value of the resistance circuit in response to the resistance value instruction received by the receiving circuit.

### [Item 31]

The vehicle lamp control device according to Item 30, wherein
the resistance circuit includes
   a first resistance element that is connected in series to the light-emitting element, and
   a second resistance element and a switch that are connected in series to the light-emitting element, and connected in parallel to the first resistance element, and
the resistance value control circuit turns on and off the switch in response to the resistance value instruction.

### [Item 32]

The vehicle lamp control device according to Item 30, wherein
the resistance circuit includes
   a first resistance element that is connected in series to the light-emitting element, and
   a diode and a switch that are connected in series to the light-emitting element in a forward direction, and connected in parallel to the first resistance element,
the resistance value control circuit turns on and off the switch in response to the resistance value instruction.

[Item 33]

The vehicle lamp control device according to Item 30, wherein
the resistance circuit includes a variable resistance element whose resistance value changes according to a control voltage, and
the resistance value control circuit outputs the control voltage.

### [Item 34]

The vehicle lamp control device according to Item 24, wherein
the vehicle lamp is a rear lamp, and
   the light-emitting element constitutes a light source of the rear lamp.

### REFERENCE SIGNS LIST

1 Vehicle lamp control device
2 Vehicle
5 Operator terminal
6 Battery
21 Central ECU
22 Front ECU
23 Rear ECU
30 Headlamp
40 Rear lamp
41 Rear lamp lighting control circuit
411 Voltage source
412 Current source
4121 Constant current source
4121a First constant current source
4121b Second constant current source
4125 Short-circuit information acquisition portion
42 LED board
45 Temperature sensor
400 LED array
405 LED
420 Resistance circuit
422 Resistance element
422a Resistance element
422b Resistance element
422c Resistance element
422d Resistance element
423 Switch
424 Diode
522a Variable resistance element
522b Resistance element
522c Resistance element
525 A/D conversion circuit
431 Communication circuit
432 Decoder circuit
433 D/A conversion circuit
434 On-off control circuit
451 Communication processing portion
452 Input/output processing portion
453 Current generation portion

1-34. (canceled)

35. A vehicle lamp control device comprising:
a first constant current source configured to supply a constant current to a light-emitting element used in a vehicle lamp;
a resistance circuit connected in series to the light-emitting element and the first constant current source;
a current value control circuit configured to control a value of a current of the first constant current source in response to a lighting state instruction for giving an instruction of a lighting state of the light-emitting element; and
a resistance value control circuit configured to change a resistance value of the resistance circuit so as to suppress a change in a value of a voltage applied to the first constant current source when a value of a current supplied to the light-emitting element changes.

36. The vehicle lamp control device according to claim 35, further comprising:
a second constant current source configured to supply a current in response to the lighting state instruction, wherein
the resistance value control circuit changes the resistance value of the resistance circuit according to the value of the current supplied by the second constant current source.

37. The vehicle lamp control device according to claim 36, wherein
the resistance circuit includes
a first resistance element that is connected in series to the light-emitting element, and
a second resistance element and a switch that are connected in series to the light-emitting element, and connected in parallel to the first resistance element, and
the resistance value control circuit turns on and off the switch according to the value of the current of the second constant current source.

38. The vehicle lamp control device according to claim 36, wherein
the resistance circuit includes
a first resistance element that is connected in series to the light-emitting element, and
a diode and a switch that are connected in series to the light-emitting element in a forward direction, and connected in parallel to the first resistance element, and
the resistance value control circuit turns on and off the switch according to the value of the current of the second constant current source.

39. The vehicle lamp control device according to claim 36, wherein
the resistance circuit includes a variable resistance element whose resistance value changes according to a control voltage, and
the resistance value control circuit outputs the control voltage according to the value of the current of the second constant current source.

40. The vehicle lamp control device according to claim 36, wherein
the first constant current source and the second constant current source are constant current sources different from each other among a plurality of constant current sources included in one integrated circuit.

41. The vehicle lamp control device according to claim 35, further comprising:
a receiving circuit configured to receive the lighting state instruction from another device communicably connected thereto, wherein
the resistance value control circuit changes the resistance value of the resistance circuit in response to the lighting state instruction received by the receiving circuit.

42. The vehicle lamp control device according to claim 35, wherein
the vehicle lamp is a rear lamp, and
the light-emitting element constitutes a light source of the rear lamp.

43. A vehicle lamp control device comprising:
a first constant current source configured to supply a constant current to a light-emitting element used in a vehicle lamp;
a resistance circuit connected in series to the light-emitting element and the first constant current source;
a current value control circuit configured to control a value of a current of the first constant current source; and
a resistance value control circuit configured to change a resistance value of the resistance circuit so as to suppress a change in a value of a voltage applied to the first constant current source when a temperature around the light-emitting element changes.

44. The vehicle lamp control device according to claim 43, further comprising:
a second constant current source configured to supply a current according to the temperature around the light-emitting element, wherein
the resistance value control circuit changes the resistance value of the resistance circuit according to a value of the current supplied by the second constant current source.

45. The vehicle lamp control device according to claim 44, wherein
the resistance circuit includes
a first resistance element that is connected in series to the light-emitting element, and
a second resistance element and a switch that are connected in series to the light-emitting element, and connected in parallel to the first resistance element, and
the resistance value control circuit turns on and off the switch according to the value of the current of the second constant current source.

46. The vehicle lamp control device according to claim 44, wherein
the resistance circuit includes
a first resistance element that is connected in series to the light-emitting element, and
a diode and a switch that are connected in series to the light-emitting element in a forward direction, and connected in parallel to the first resistance element, and
the resistance value control circuit turns on and off the switch according to the value of the current of the second constant current source.

47. The vehicle lamp control device according to claim 44, wherein
the resistance circuit includes a variable resistance element whose resistance value changes according to a control voltage, and
the resistance value control circuit outputs the control voltage according to the value of the current of the second constant current source.

48. The vehicle lamp control device according to claim 43, further comprising:
a temperature information acquisition circuit configured to acquire temperature information indicating a temperature around the light-emitting element;
a notification circuit configured to notify another device communicably connected thereto of the temperature information; and
a receiving circuit configured to receive a resistance value instruction for giving an instruction of the resistance value of the resistance circuit, the receiving circuit being configured to be notified of the resistance value instruction generated by the other device, based on the temperature information, wherein
the resistance value control circuit changes the resistance value of the resistance circuit in response to the resistance value instruction received by the receiving circuit.

49. A vehicle lamp control device comprising:
a first constant current source configured to supply a constant current to a light-emitting element used in a vehicle lamp;
a resistance circuit connected in series to the light-emitting element and the first constant current source;
a current value control circuit configured to control a value of a current of the first constant current source; and
a resistance value control circuit configured to change a resistance value of the resistance circuit so as to suppress a change in a value of a voltage applied to the first constant current source when the light-emitting element is short-circuited.

50. The vehicle lamp control device according to claim 47, further comprising:
a second constant current source configured to supply a current according to presence or absence of a short circuit of the light-emitting element, wherein
the resistance value control circuit changes the resistance value of the resistance circuit according to the value of the current supplied by the second constant current source.

51. The vehicle lamp control device according to claim 48, wherein
the resistance circuit includes
a first resistance element that is connected in series to the light-emitting element, and
a second resistance element and a switch that are connected in series to the light-emitting element, and connected in parallel to the first resistance element, and
the resistance value control circuit turns on and off the switch according to the value of the current of the second constant current source.

52. The vehicle lamp control device according to claim 48, wherein
the resistance circuit includes
a first resistance element that is connected in series to the light-emitting element, and
a diode and a switch that are connected in series to the light-emitting element in a forward direction, and connected in parallel to the first resistance element, and
the resistance value control circuit turns on and off the switch according to the value of the current of the second constant current source.

53. The vehicle lamp control device according to claim 48, wherein
the resistance circuit includes a variable resistance element whose resistance value changes according to a control voltage, and
the resistance value control circuit outputs the control voltage according to the value of the current of the second constant current source.

54. The vehicle lamp control device according to claim 47, further comprising:
a short-circuit information acquisition portion configured to acquire short-circuit information indicating presence or absence of a short circuit of the light-emitting element;
a notification circuit configured to notify another device communicably connected thereto of the short-circuit information; and
a receiving circuit configured to receive a resistance value instruction for giving an instruction of the resistance value of the resistance circuit, the receiving circuit being configured to be notified of the resistance value instruction generated by the other device, based on the short-circuit information, wherein
the resistance value control circuit changes the resistance value of the resistance circuit in response to the resistance value instruction received by the receiving circuit.
